(19) United States
(12) Patent Application Publication
(10) Pub. No.: US 2006/0011458 A1
(43) Pub. Date: Jan. 19, 2006

(54) Components

(76) Inventor: Dale McPhee Purcocks, Brookfield Terrace (IE)

Correspondence Address: STITES & HARBISON PLLC, 424 CHURCH STREET, SUITE 1800, NASHVILLE, TN, 37219-2376, US

(21) Appl. No.: 10/515,568

(22) PCT Filed: Mar. 31, 2003
(86) PCT No.: PCT/IB03/01697

§ 371 Date: Aug. 2, 2005

(30) Foreign Application Priority Data
May 22, 2002 (ZA) 2002/4049
Jun. 12, 2002 (ZA) 2002/4706
Jun. 12, 2002 (ZA) 2002/4707
Jul. 5, 2002 (ZA) 2002/5375
Jul. 5, 2002 (ZA) 2002/5376
Oct. 25, 2002 (GB) 0224988.6

(51) Int. Cl. H01H 9/00

(52) U.S. Cl. 200/310

(57) ABSTRACT

Switches and keyboards, and methods and apparatus for manufacturing same, which may employ an arrangement comprising a plurality of resiliently flexible biasing members (20) that are joined directly to one another, in a substantially side-by-side configuration to form a continuous, flexible string (10) of biasing members.

This invention relates to a method and apparatus for making continuous strings of moulded articles, a method and apparatus for placing components supplied in continuous moulded strings, switches with elastomeric biassing members and switches of the push button type.

Keyboards for computers and the like typically comprise an array of key caps supported in an upper cover, a contact membrane, and an elastomeric pad interposed between the keys and the contact membrane. The elastomeric pad, usually of silicone rubber, has integrally moulded domes to bias each key cap away from the contact membrane. The pad constitutes a significant portion of the cost of the keyboard and much of this cost is wasted just to join the domes together. Further cost is incurred if the pad has to be discarded, which becomes necessary if even one of the domes is defective. Furthermore, different pad moulds have to be made for each keyboard configuration, which is restrictive, expensive and time-consuming.

The problems set out above associated with the elastomeric pad could be reduced by using an individual resilient domed member for each key cap, but then positioning the members in relation to the keys accurately, reliably and quickly is problematic. This is primarily because the material used to make the domed members is soft pliable and slippery, and thus presents problems for automating the process, either by grasping such domes on a tray, feeding them from a hopper or releasably attaching them to a carrier strip.

Thus, a first aspect of this invention seeks to provide the elastomeric domes in a form that is satisfactory for feeding them in an automated placing machine. The first aspect of the invention also seeks to provide a method and apparatus for making such domed members.

According to a first aspect of the present invention, there is provided an arrangement comprising a plurality of resiliently flexible biasing members that are joined directly to one another, in a substantially side-by-side configuration to form a continuous, flexible string of said biasing members.

The joined members can be easily and reliably fed and handled in aplacing machine, with the members being severed from the string (i.e. separated from each other) at a desired stage in the process and/or location in such a machine. The continuous string of resilient members should be of sufficient length to supply such members to an automated placing machine for a desired period of time.

The members themselves may abut one another, or may be interconnected by integral connecting pieces as desired, and/or dictated by the production process. The biasing members may be of a substantially dome-like configuration, preferably moulded of an elastomeric material, such as resilient silicone rubber.

Automated placing machines typically form part of a production line, each component or step of which must operate in step with the other components, otherwise the whole production line must be stopped. Thus, the period for which a string is required to feed members to the placing machine is ideally selected to avoid unnecessary downtime of the machine and production line. Depending on the circumstances, the period may typically range from about 0.5 to 24 hours, and the length of the string is adjusted accordingly.

Also in accordance with the first aspect of the present invention, there is provided a method of making an arrangement as defined above, the method including the steps of:
moulding a first length of interconnected biasing members in a mould having a plurality of adjacent moulding formations interconnected by connecting passages arranged in a line, there being a first formation at one end and a last formation at the opposite end of the line, with a first biasing member being formed in the first formation;
removing said first moulded length, advancing it relative to the mould until the first biasing member registers with the last formation of the mould, and inserting the first member into the last formation; and
moulding a second length of biasing members, the first member of said first length being caused to be joined to said second length of members.

In continuous use, material is not deliberately injected into the last formation, which merely serves to hold the first member from a previously-moulded string. However, material will and must flow towards the last moulding formation along the connecting passage from the adjacent formation for welding the lengths to each other.

Also in accordance with the first aspect of the present invention, there is provided apparatus for making an arrangement as defined above, the apparatus comprising:
a mould having a plurality of moulding formations interconnected by connecting passages and arranged in a line for moulding a length of interconnected biasing members, there being a first formation at one end and a last formation at the opposite end of the line;
gripping means for releasably engaging a biasing member moulded in the first formation; and
progressing means for moving the gripping means between the first and last formations in order to remove a biasing member formed in the first formation from the first formation, advance said biasing member along the length of the line and position it in the last formation of the mould.

The mould may have male and female parts that form a moulding formation when the mould parts are brought together. The mould may be configured, or means such as suction may be provided, to releasably retain a moulded length on one of the parts, the first member being removed from and inserted in or onto the same mould part. The mould part may be the male or female part, as desired.

Preferably, means are provided to hold the first member in or on the appropriate part of the last moulding formation. Preferably, such holding means comprises or includes suction means, in which case a port may be provided in the mould part formation and means may be provided to apply (preferably selectively) suction to the port.

The gripping means preferably uses suction to grip the members, although mechanical gripping means may be provided if desired and appropriate.

In a preferred embodiment, the progressing means reciprocates the gripping means between the first and last formations. Alternatively, if desired, the progressing means may include an endless loop provided with a desired number of gripping means that advance in steps from the first to the last formation.

Preferably, the mould includes a plurality of adjacent lines of interconnected moulding formations and the gripping means is constructed so as to releasably engage a member moulded in the first formation of the or each line.

In one preferred embodiment of the invention, the mould may be arranged such that the line of interconnected moulding formations extends substantially vertically in use. Preferably, in use, the moulded lengths that have been removed from the mould hang below the mould, with the member moulded in the first formation engaged in the last formation of the mould for the next moulding operation.

Preferably, the connecting passages form connecting pieces between the moulded members. Preferably a portion of a connecting passage is formed in the mould extending away from the first moulding formation. This forms a small connecting piece that readily welds to moulding material tending to flow into the last formation from the adjacent formation.

The continuous string of moulded members may be wound onto a suitable spool, although it is preferred to store the string(s) in overlying lengths in a deep narrow receptacle.

Second and third aspects of the present invention relate to a method and apparatus for placing components supplied in continuous strings of moulded articles, and is concerned primarily, though not necessarily exclusively, with a step in assembling keyboards, control panels and similar “keypads” comprising a multiple switch membrane, a plurality of keys for selectively closing the switches, and an elastomeric member for each key to bias the keys away from the membrane.

As explained above, typically, particularly for high volume keypads such as computer keyboards, the elastomeric members are provided as an array of domes integrally moulded in a pad of silicone rubber or similar elastomer. Such pads have several undesirable characteristics. For example, they are relatively expensive and form a significant portion of the cost of each keyboard, and are suitable for specific key configurations only. It is known to use individual domes, but this presents the keypad manufacturer with the problem of positioning the domes accurately, reliably and quickly on an assembly line. Such domes provide feeding problems for placing robots, as they are not suited to grasping, feed bowls or hoppers, or sorting trays, nor do they adhere reliably to carrier strips. Thus, it is difficult to achieve the speed required for volume production using individual domes.

Another problem with keypads, such as control panels, is that they are not standardised and may have any number of keys in any desired array. Even computer keyboards, while generally similar and having a basic, so-called “QWERTY” arrangement, are made in a variety of forms with different numbers of keys, pitches between rows of keys and keys in a row, number of rows and number and location of additional or special-purpose keys. Generally, the number of keys may range from 88 to about 110, arranged in 6 to 8 rows.

It has been discovered that the domed members can be fed reliably if they are formed as an integral, continuous string of joined members, and the this concept, together with a method and apparatus for making such strings is disclosed above in relation to the first aspect of the present invention. The second aspect of the present invention seeks to provide a method and apparatus to place individual elastomeric domed members in desired configurations using such strings.

Thus in accordance with the second aspect of the present invention, there is provided a method of placing a component on a body using a placing head, the component being one of a string of components integrally joined to one another, the method including the steps of:
feeding the string to the placing head;
engaging at least the last component at a free end of the string with the placing head;
positioning the placing head at a desired position with respect to the body; and
releasing and placing the last component on the body,
the string being cut to separate the last component from the string.

In a preferred embodiment, the string is cut prior to releasing and placing the last component on the body.

In the case that the method is for placing a plurality of components in an array of rows on a body, such as resilient domes for a keypad, the method preferably includes moving the placing head and body relative to each other sequentially to each desired position where a component is to be placed.

The relative movement may be effected by moving the placing head while the body is stationary, or moving the body while the placing head is stationary, or moving both the body and placing head simultaneously, as desired.

In the event that the placing head is moved, the method may include the steps of moving the placing head and placing the components in a first row along the body, moving the placing head to align with the next row and placing the components in the next row, and so on.

Alternatively, the method may include using a plurality of adjacent placing heads, each head being arranged to align with one row, and moving each placing head to place the components along its respective row. The placing heads may move in unison to enable one or several components to be placed at substantially the same time, depending on the relative alignment of the components in the respective rows. Preferably, however, the placing heads move independently of one another, each head placing a components at a desired position along its row.

In a preferred embodiment, the components are placed sequentially in each row.

Beneficially, each placing head returns to a starting position at one end of the body before placing each row of components. This is not essential, but is preferred for programming the movement of the placing head, positioning sensors, and controlling the movement of the body and the placing head in response to the sensors.

Where there is a plurality of placing heads, the method includes returning each placing head to the starting position when it has completed placing components in its respective row, and thereafter moving the next body into position in relation to the placing heads.

Also in accordance with the second aspect of the present invention, there is provided apparatus for placing a component on a body, the component being one of a string of components integrally joined to one another, the apparatus comprising:
a placing head, including engaging means to releasably engage at least the last component at the free end of the string, cutting means to separate the last component from the string, and actuating means to place the separated last component on the body;
a movable support member supporting the placing head;
support moving means for moving the support member from a starting position to an end position and back again in a first direction; and
string support means to support the string in a path from a receptacle to the placing head.

In a preferred embodiment, the engaging means includes a component bearing formation and a port to supply air at pressure to the bearing formation. Control means is provided to selectively apply low pressure (vacuum) to hold the component on the bearing formation. Preferably, the control means also applies high pressure (i.e. above atmospheric pressure) to positively release the component from the bearing formation. It will be appreciated, however, that other means for engaging the component may be used, such as mechanical gripping means, electrostatic or magnetic means, as suited to the material of the component being placed.

The supporting member may be movable along a second direction perpendicular to the first direction, such that components can be placed in a desired number of parallel rows.

The apparatus may include a plurality of supporting members, each provided with a placing head, each for placing a row of components in the first direction.

In a preferred embodiment, the placing head comprises an indexing member provided with a plurality of engaging means, the indexing member being movable to progress the engaging means in an endless path that intersects the path of the string and has a portion adjacent to the body at a position where a component is to be placed.

Preferably, the indexing member is a rotatable, cylindrical body, with a plurality of engaging means being provided around the periphery of the body. The indexing member may alternatively be an endless band supported on at least two spaced rollers, the engaging means being provided on the band.

Also in accordance with the second aspect of the present invention, there is provided a placing head for placing a component on a body, the component being oine of a string of components integrally joined to one another, the placing head comprising:
engaging means for releasably engaging at least the last component at the free end of the string;
cutting means for separating the last component from the string; and
actuating means to cause the separated last component to be placed on the body.

Additional features of the placing head may be as described above in connection with the above-mentioned method and apparatus for placing a component on a body.

A third aspect of the present invention seeks to provide a method and apparatus that can quickly place the domed members using strings of such members.

In accordance with the third aspect of the present invention, there is provided a method of placing components on a body, each component being one of a string of components joined to one another, the method including the steps of:
feeding a plurality of strings of components to a row of desired spaced positions along an elongate indexing member;
releasably attaching an end component of each string to the indexing member;
separating each end component from its respective string;
transferring the row of separated components from the indexing member to an elongate placing member, the components being releasably attached to the elongate placing member; and
transferring the separated components in a row from the placing member to the body; each step being performed substantially simultaneously on all of the components in a row.

In a preferred embodiment, the method includes the step of retaining the strings in engagement with the indexing member, more preferably by releasably attaching at least the end and next-to-end components of each string to the indexing member.

Preferably, the method includes moving the indexing member from a first position to attach the end components to a second position to transfer the components to the placing member.

A development of the method according to the third aspect of the present invention includes the steps of substantially simultaneously placing a row of components in a desired position on a plurality of bodies, advancing the bodies and placing a further row of components, and so on as required in order to place an array of spaced rows of components on each body.

Also according to the third aspect of the present invention, there is provided apparatus for placing components on a body, each component being one of a string of components joined to one another, the apparatus comprising:
an elongate indexing member, the indexing member having engaging means for releasably engaging at least one component of each string with the indexing member;
means for separating an end component from each string;
an elongate placing member, the placing member having transfer means for releasably receiving components from the indexing member, and at least one of the indexing and placing members being movable to a position in which components can be transferred from the indexing member to the placing member; and
means for moving at least one of the body and the placing member to a position in which components can be transferred from the placing member to the body.

The indexing member may be an endless band, although it is more preferably a cylindrical body. In either case, the indexing member preferably rotates in one direction in steps in order to move components from an engaging position to a discharge position in which the components are presented to the placing member. The indexing member may move several steps between the engaging and discharging positions. In the latter event, the last component may be separated from the string at any desired step or position.

In a preferred embodiment, the placing member is movable from a receiving position in which it is adjacent the indexing member, to a depositing position in which it is adjacent the body.

Also in accordance with the third aspect of the present invention, there is provided a multi-stage placing assembly, comprising:
a plurality of placing apparatuses as defined above, arranged at spaced positions along a path; and
conveyor means to move bodies on which components are to be placed along the path.

The conveyor means is preferably arranged to move the bodies in increments corresponding the positions of the plurality of apparatuses.

The placing assembly can place components in a two-dimensional array of rows and columns, such as an array of individual elastomeric domes for a keyboard, in substantially simultaneous stages. For example, a first apparatus can place domes in selected positions of a first row, a second apparatus can place domes in selected positions of a second row, and so on. By operating substantially simultaneous stages, a completed array can be produced each time the conveyor moves a stage.

Fourth and fifth aspects of the invention relate to switches with elastomeric biassing members, such as those used in computer keyboards and similar keypads.

Computer keyboards comprise a keycap support housing, a multiple switch membrane, a plurality of key caps slidably guided in the housing for selectively closing the membrane switches, and an elastomeric member for each key to bias the key away from the membrane. Typically, the elastomeric members are provided as an array of domes integrally moulded in a mat of silicone rubber or similar elastomeric material. As explained above, such pads have several undesirable characteristics, for example, they are relatively expensive and form a significant portion of the cost of each keyboard, and are suitable for specific key configurations only.

While individual domes may be used instead of multi-dome mats, these are not suited to fully automated keyboard assembly plants. Such domes present serious feeding difficulties for placing robots, as they are not suited to grasping, feed bowls, or sorting trays, nor do they adhere reliably to carrier strips. Also, partially assembled keyboards must be handled with care to avoid dislodging such separate domes from support housings or carriers during intermediate assembly phases. Dome mats used in an appropriate construction can protect against spilt liquids, but this cannot be easily achieved using individual domes.

The first, second and third aspects of the invention, as defined above, provide methods and systems for reliably making, feeding and positioning such domes in two-dimensional arrays, as well as for individual switches. The fourth and fifth aspects of the invention seek to develop these aspects further, by providing a system for holding such domes in place and, optionally, forming a substantially spill proof seal with such domes.

In accordance with the fourth aspect of the present invention, there is provided a switch comprising a button, a housing, a pair of contacts, and an elastomeric member received in a recess in the housing for biasing the button away from the contacts, wherein the elastomeric member has a resilient body portion and a peripheral body rim around the body portion; and wherein the switch further comprises clamping means, connected to or formed integrally with either the housing or the elastomeric member, for securing at least a portion of the rim to the housing to create a fluid-tight seal therebetween, said clamping means being movable between an open configuration in which said elastomeric member can be introduced into or removed from said recess and a sealed configuration in which said fluid-tight seal between said housing and said elastomeric member is created.

Also in accordance with the fourth aspect of the invention, there is provided a method of assembling a switch comprising a button, a housing, a pair of contacts and an elastomeric member having a resilient body portion and a peripheral body rim around the body portion, the method comprising the steps of introducing said elastomeric member into a recess in the housing, and applying means, after said member has been introduced into said recess for creating a fluid-tight seal between at least a portion of the rim and the housing.

Also in accordance with the fourth aspect of the present invention, there is provided a mechanism for a switch comprising a housing and an elastomeric member received in a recess in the housing for biasing a button of a switch away from a pair of contacts, wherein the elastomeric member has a resilient body portion and a peripheral body rim around the body portion, and wherein the mechanism further comprises means, connected to or formed integrally with either the housing or the elastomeric member, for securing at least of the rim to the housing so as to create a fluid-tight seal between the portion of the recess in the housing surrounding the upper surface of the elastomeric member and the atmosphere in which the mechanism is located.

The securing means or clamping member may be a separate component that is fitted into a region of the recess and engages the housing and the rim of the elastomeric member. Preferably, this component is a force fit in the recess, though additionally or alternatively inter-engaging formations may be provided on the component and wall of the recess.

Preferably, however, the clamping member is a portion of the material of the housing that has been deformed to extend over and engage the rim of the elastomeric member, or a portion of the material of the rim of the elastomeric member that has been deformed to engage an edge of the housing. Preferably, the housing is formed with a suitably positioned lip member that is heated and deformed to extend over the rim of the elastomeric member.

The elastomeric member may be in the form of a dome or other shape as is desired for the function it is to perform.

The clamping member may engage the entire periphery of the rim or a portion thereof only, as desired.

Preferably, a seal is formed between the elastomeric member and the housing.

The switch may be formed as a separate article or it may be formed as one of a series or array of substantially similar switches, such as in a computer keyboard or similar keypad.

Also in accordance with the fourth aspect of the present invention, there is provided a plastics housing for a switch as defined above, the housing comprising a body formed with a recess for receiving said elastomeric member wherein said clamping member comprises at least one rib formed around at least a portion of the recess, the rib being deformable to trap the elastomeric member in the recess, thereby to create the fluid-tight seal therebetween.

The housing may be formed with an array of recesses, each of which is provided with a deformable rib.

Preferably, the rib extends around the entire periphery of the recess.

Also in accordance with the fourth aspect of the present invention, there is provided a method of assembling a switch as defined above, the method including the steps of:
fitting the elastomeric member into the recess; and
deforming a portion of the housing surrounding the recess to trap the elastomeric member in the recess.

The method may include the step of heating a portion of the housing surrounding the recess prior to deforming the material to trap the elastomeric member.

Also in accordance with the fourth aspect of the present invention, there is provided apparatus for trapping an elastomeric member in a recess in a housing of a switch as defined above, the apparatus comprising a support arm, means to move the arm in a path, at least one deforming head, and means for moving the deforming head between a first position in which it is clear of the housing and a second position in which it is able to apply pressure to the housing.

The apparatus may comprise means for applying heat to at least a selected portion of the housing to facilitate deforming that portion.

The heating means may be the deforming head itself which is heated. Alternatively, the heating means may be an inductive or radiant heating element on the head that is constructed to heat the selected region prior to moving the deforming head against the selected region.

Also in accordance with the fourth aspect of the present invention, there is provided a keypad including a plurality of switches, the keypad comprising a housing member formed with a row of recesses, a unitary resilient member received at least partly in at least one of the recesses, and a clamping means for each recess trapping the resilient member in the recess, thereby to create a fluid-tight seal between said resilient member and said housing member.

Preferably the resilient member is an elastomeric member. Preferably, each elastomeric member is sealed to the housing.

The keypad may include a button or key cap for each switch, the button being sidably guided with respect to the housing, abutting the resilient member and having means keeping it in contact with the housing and the resilient member of each switch.

Each button may be provided with a post that is slidably guided in the housing and that abuts the resilient member in use.

A typical push button switch for use in assemblies, such as keypads, comprises a housing, a button movable with respect to the housing, a pair of contacts connectable to each other when the button is depressed, a metal spring member for biassing the button away from at least one of the contacts, and means for retaining the button engaged with the housing. The contacts are usually fixed in the housing and external or externally accessible terminals. The “feel” of such switches may vary as desired, such as soft push, click, positive on/off positions, and so on, but in practice each such switch has to be purpose made. Reliability and consistency are often problems with such switches.

A keypad, for example, for controlling a machine or process plant, may be made up by assembling a suitable array of separate switches on a board. The switches may be connected by separate wires to he circuits they are to control or may be soldered to a printed circuit board.

If the number of keypads required is insufficient to justify making moulds and using placing robots, then assembling a large number of keypads, say 100, manually can be onerous, particularly if each keypad has numerous switches. Even making a few keypads can be a problem, as each is in effect custom made in this event, and care has to be taken to ensure uniformity.

Thus, one object of the fifth aspect of the present invention is to provide a push button switch that will function reliably and can be relatively easily modified for different “feel” and/or characteristics. Another object of the fifth aspect of the invention is to provide a push button switch that can be assembled satisfactorily easily and quickly to form a keypad. Yet another object of the fifth aspect of the present invention is to provide means for making a customised keypad assembly in a reasonably satisfactory manner.

Thus, in accordance with the fifth aspect of the present invention, there is provided a switch comprising a housing, a button and an elastomeric member substantially contained in the housing for resiliently biassing the button away from the housing, wherein the housing is configured to be directly connected or joined to one or more other housings.

The button may have an integral post that is slidably guided in the housing, the post being arranged to bear against the elastomeric member.

The button and the elastomeric member may be provided with suitable formations for connecting them to each other so as to retain the button engaged with the housing. The connecting formations may have interlocking formations or parts, or may frictionally engage each other, or may be bonded to each other with a suitable adhesive. Additionally or alternatively, the button may have a connecting formation for holding it in engagement with the housing, the button and member being arranged and constructed to inhibit lateral movement relatively to each other.

The elastomeric member may have at least one projecting formation forpushing one electrical contact against another electrical contact.

Additionally or alternatively the elastomeric member may have a conductive formation or coating for electrically bridging two electrical contacts.

Retaining means may be formed internally of the housing, such as an internal lip or lip portions, for retaining the elastomeric member in the housing.

The elastomeric member may have a hollow domed or conical structure.

Preferably the housing is substantially rectangular.

Adjacent housings may be configured externally to be adhesively bonded or welded to one another. Additionally or alternatively, the housings may have interlocking formations for connecting one housing to an adjacent housing.

Also in accordance with the fifth aspect of the present invention, there is provided a switch comprising a housing, a button, an elastomeric member substantially contained in the housing for resiliently biassing the button with respect to the housing, and a plurality of interlocking formations for connecting the housing of one switch to the housing of an adjacent switch.

Preferably, the switch is arranged such that there is a base at one side the housing, the button being positioned on the side of the housing remote from the base, and the interlocking formations are bulbed ribs and substantially complementary undercut grooves, the formations of one switch being engageable with the complementary formations of an adjacent switch by sliding the ribs along the grooves.

Preferably, each of the ribs and grooves has a first portion with a first cross-section, a second portion with a relatively larger cross-section, the material of the housing being sufficiently resilient to permit the second relatively larger portion to pass through the first portion. This construction permits adjacent housings to be inter-engaged by moving them relatively to each other in one direction, but inhibits them from being disengaged accidentally or undesirably.

The transition between the first and second portions may be progressive or may be formed by a shoulder or step that further inhibits disengagement of adjacent housings.

Preferably the relative lengths of he first and second portions of each of the rib and the groove formations are chosen such that there is some free play or relative movement of adjacent housings before the shoulders abut one another—this is to enable setting of the switches on a surface that may be uneven.

Preferably the arrangement of the first and second portions of pairs of ribs and grooves that will be mated in use is such that, once engaged, the housings are inhibited from being separated in either direction along the length of the ribs and grooves.

At least some of the ribs may be formed with a double taper along their length, the thickness or cross-section of each rib decreasing outwardly from a medial region of he rib. At least some of the grooves may be formed longitudinally with a double taper, the width or cross-section of the groove decreasing from its ends towards a medial region. The medial regions of the ribs and grooves may be at any desired position along their respective lengths.

The free ends of at least one of the ribs and grooves may be chamfered to facilitate initial engagement of the ribs and grooves.

Preferably the housings are formed by moulding and the boundaries between the first and second portions or the interfaces between tapering portions are formed along mould lines.

The elastomeric member may be in the form of a dome, the dome having a substantially planar base, a domed portion above the base and a locating formation at the top region of the dome.

The locating formation is used either to locate the member with respect to the button or the housing of a switch.

Also in accordance with the fifth aspect of the invention, there is provided a keypad comprising a plurality of switches, each comprising a housing, a button, a substantially planar switch member provided with a plurality of pairs of spaced contacts with a pair od contacts being in register with each of the switches, and means for resiliently biassing the button away from the switch member, and means for connecting the switches to each other.

Preferably, the planar member is a contact membrane, though it may be a printed circuit board or the like.

Preferably the means for connecting the switches to each other comprises inter-engaging formations formed on the housing of the switches. The switches may also be bonded by adhesive or welded to one another, though neither are preferred because of the cost of suitable adhesive, additional steps involved and additional equipment required for assembly of the keypad.

Each of the switches may be substantially similar in shape and size to enable a regular two-dimensional array to be formed. In this event, blank housings may be provided for filling the interstices between switch housings. Such blank housings may have a height greater than that of the switch housings, so that the surface of an assembled keypad has a desired appearance, i.e. the visible surface of the buttons of the switches and the upper portions of the blank housings may be substantially in line with each other. Cover plates or elements engageable with the blank housings may be provided for this purpose.

The switches may also be different and be formed and shaped to provide keys for a computer keyboard and the like.

Embodiments of the various aspects of the present invention will now be described by way of examples only. Further features, variants and/or advantages of the various aspects of the invention will become apparent from the following non-limiting description of examples of the various aspects of the invention, made with reference to the accompanying schematic drawings, in which:

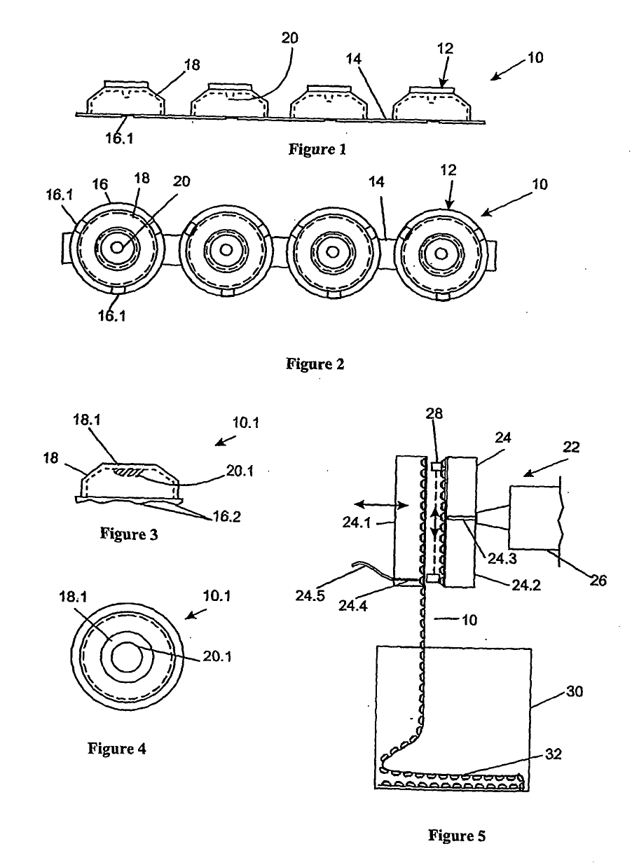

FIG. 1 shows a side view of a portion of a string of interconnected domed members for a keyboard;

FIG. 2 shows a plan view of the string of FIG. 1;

FIGS. 3 and 4 show a side and plan view of another form of domed member for a keyboard;

FIG. 5 shows a schematic side view of an apparatus for making a continuous string of interconnected moulded members according to the invention;

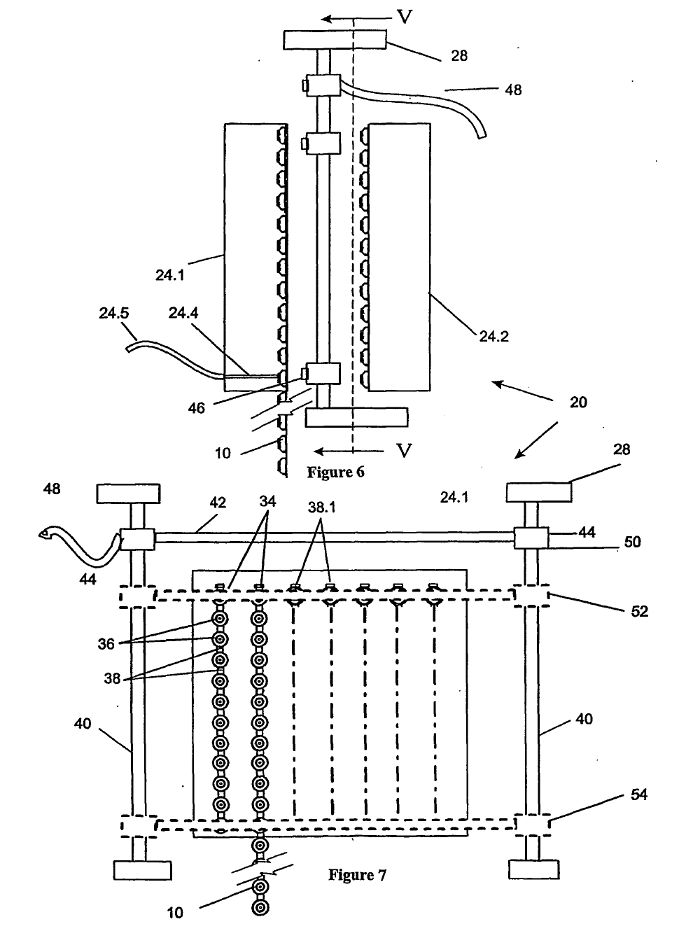

FIG. 6 shows a side view of part of the apparatus of FIG. 3 in greater detail;

FIG. 7 shows an end view along V-V of FIG. 4;

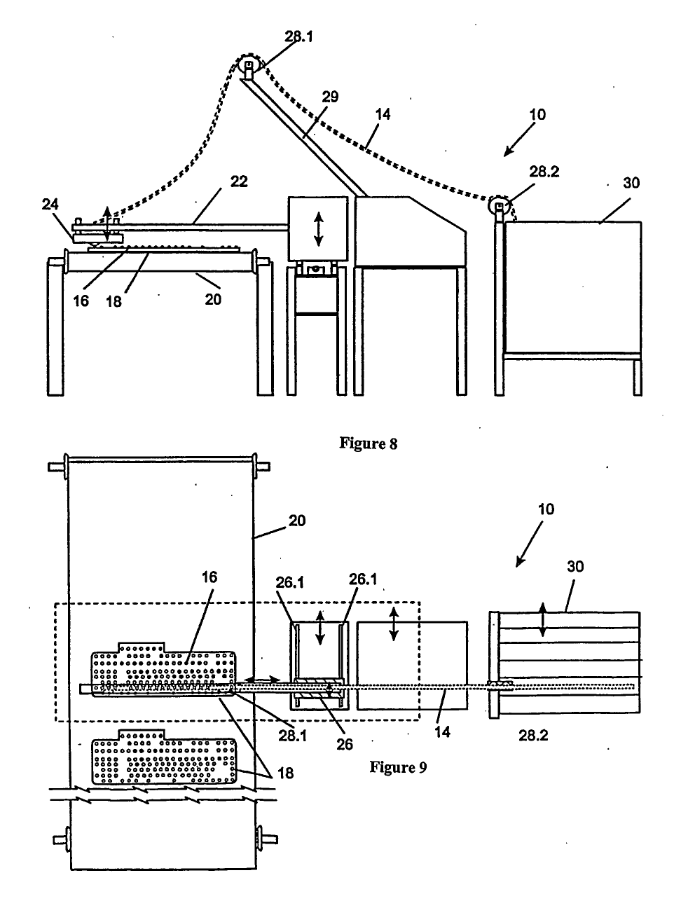

FIG. 8 shows a side view of an exemplary embodiment of placing apparatus of the second aspect of the invention;

FIG. 9 shows a plan view of the placing apparatus of FIG. 8;

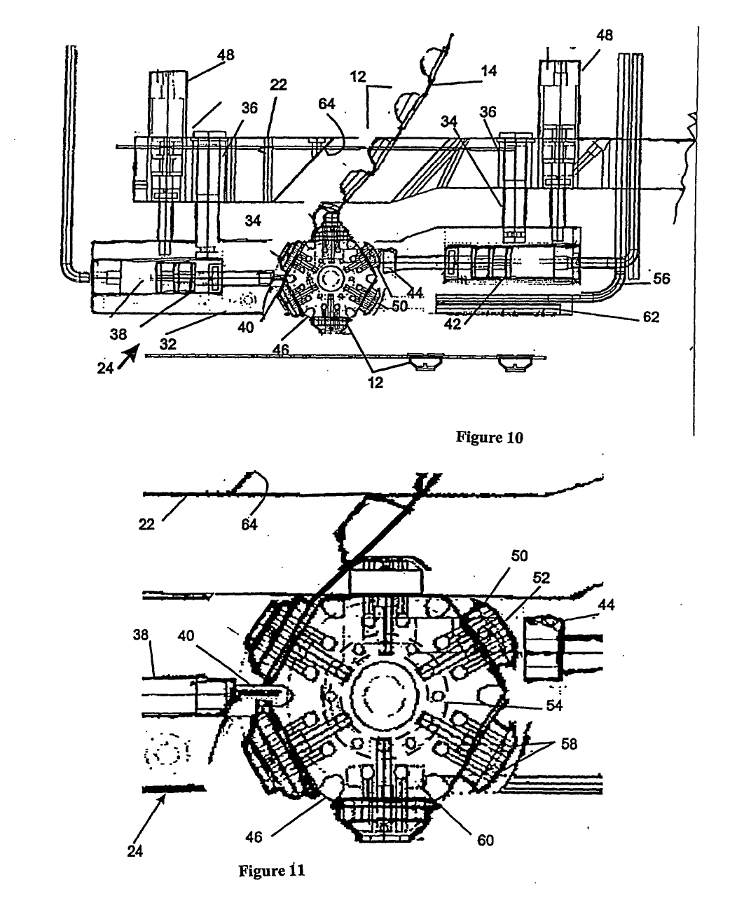

FIG. 10 shows a side view on an enlarged scale of a placing head forming part of the apparatus of FIG. 8;

FIG. 11 shows a side view detail of part of the placing head of FIG. 10;

FIG. 12 shows a plan view of an exemplary embodiment of a multiple placing head apparatus of the second aspect of the invention, the view corresponding to the portion of the apparatus of FIG. 8 enclosed in a dashed line box;

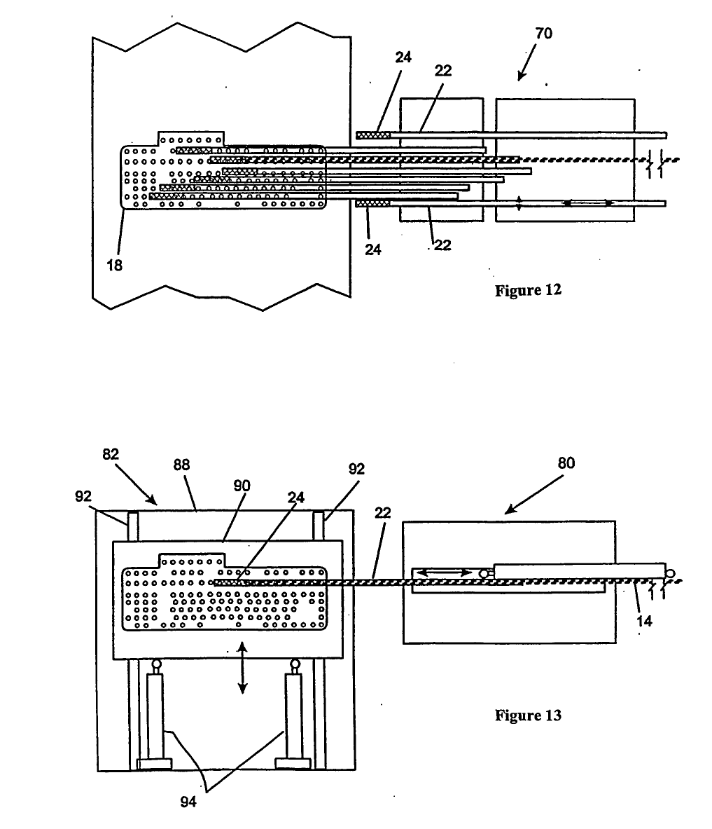

FIG. 13 shows a plan view of a single arm placing head apparatus of the second aspect of the invention used with a movable keyboard mount;

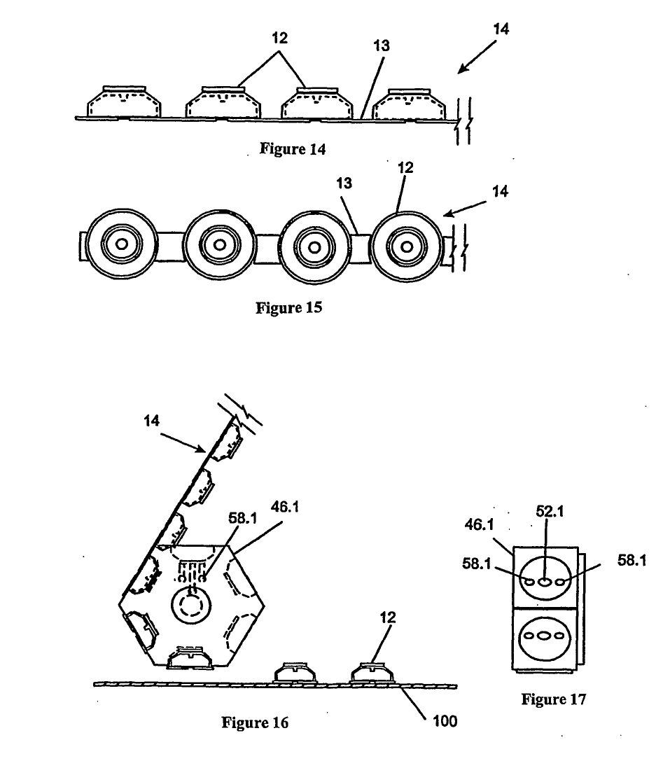

FIG. 14 shows a side view of a portion of an integrally joined, continuous string of domes;

FIG. 15 shows a plan view of the portion of the string of FIG. 12;

FIG. 16 shows a side view of another engaging means for an exemplary embodiment of a placing head of the second aspect of the invention;

FIG. 17 shows an end view of the engaging means of FIG. 14;

FIG. 18 shows a side view of an exemplary embodiment of a placing assembly of the third aspect of the invention;

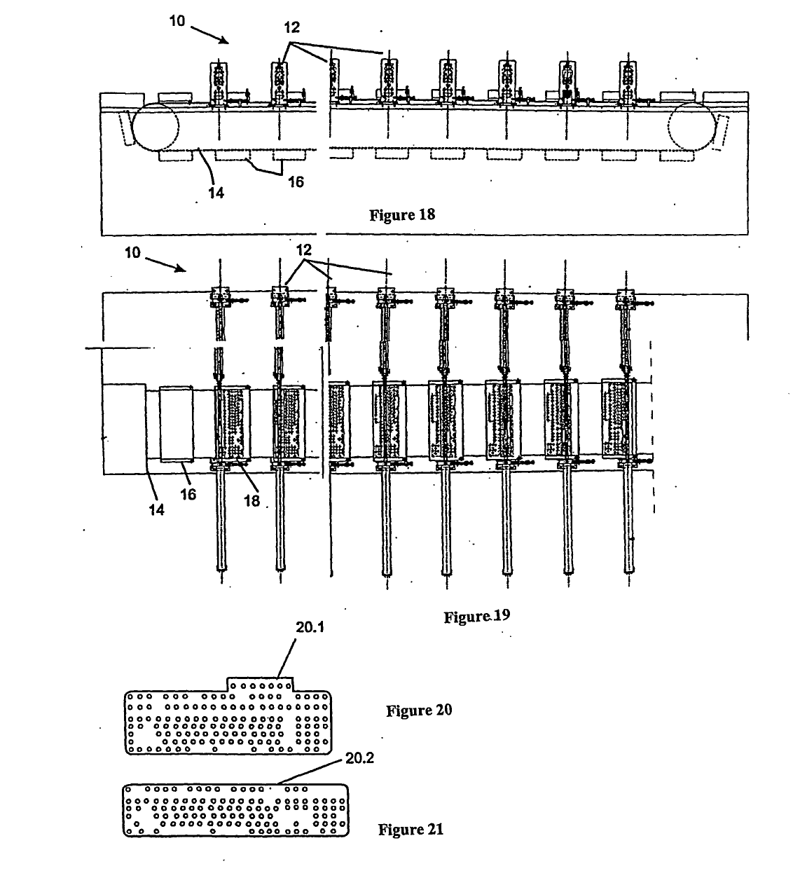

FIG. 19 shows a plan view of the placing assembly of FIG. 18;

FIGS. 20 and 21 show examples of two different keyboard layouts as may be encountered in practice;

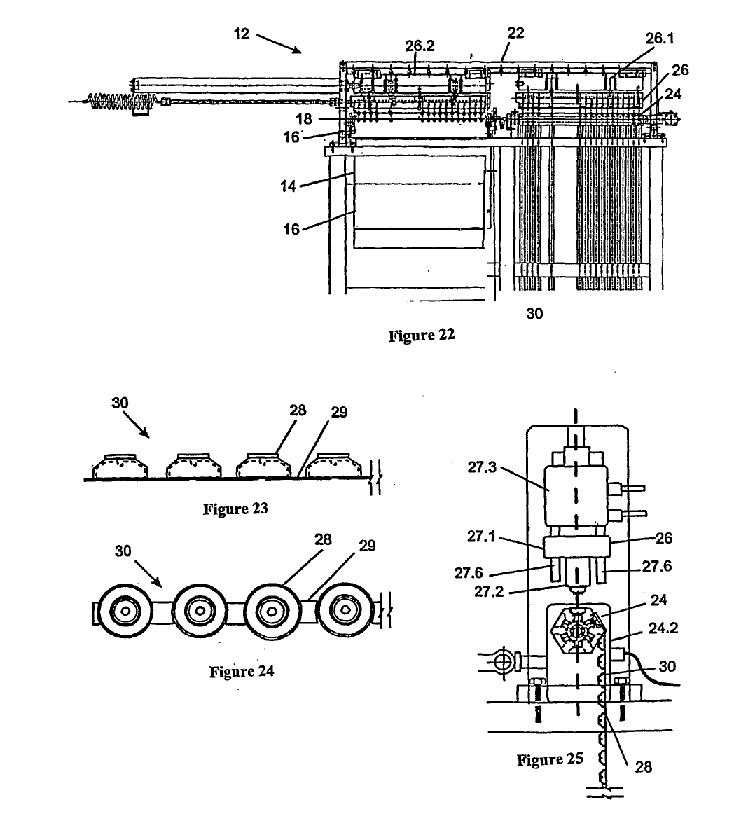

FIG. 22 shows a side view of a placing apparatus forming one stage of the assembly of FIGS. 18 and 19;

FIGS. 23 and 24 show side and plan views of a string of integrally moulded rubber domes;

FIG. 25 shows an enlarged end view of part of the placing apparatus of FIG. 22;

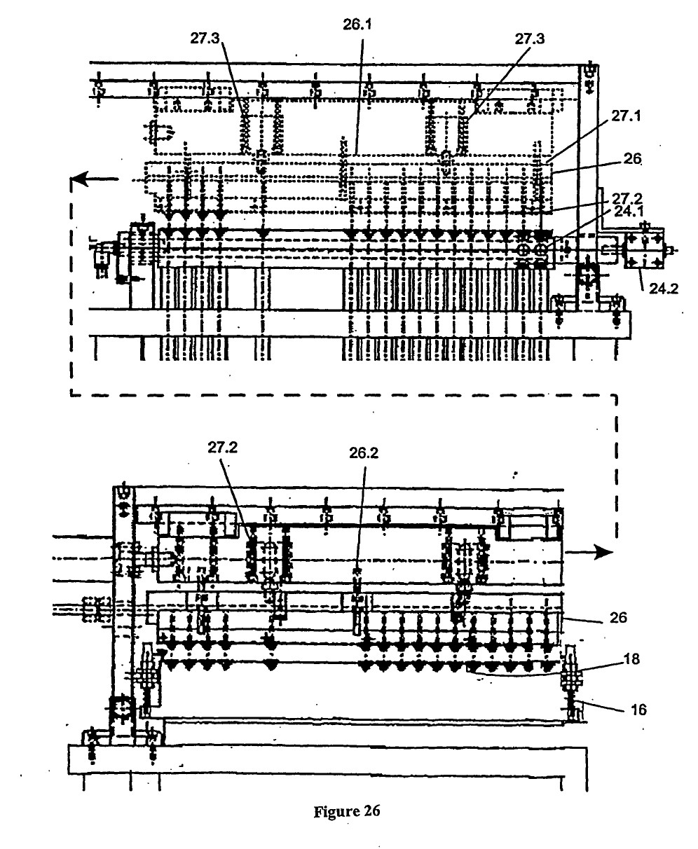

FIG. 26 shows an enlarged, exploded side view of the part shows in FIG. 22

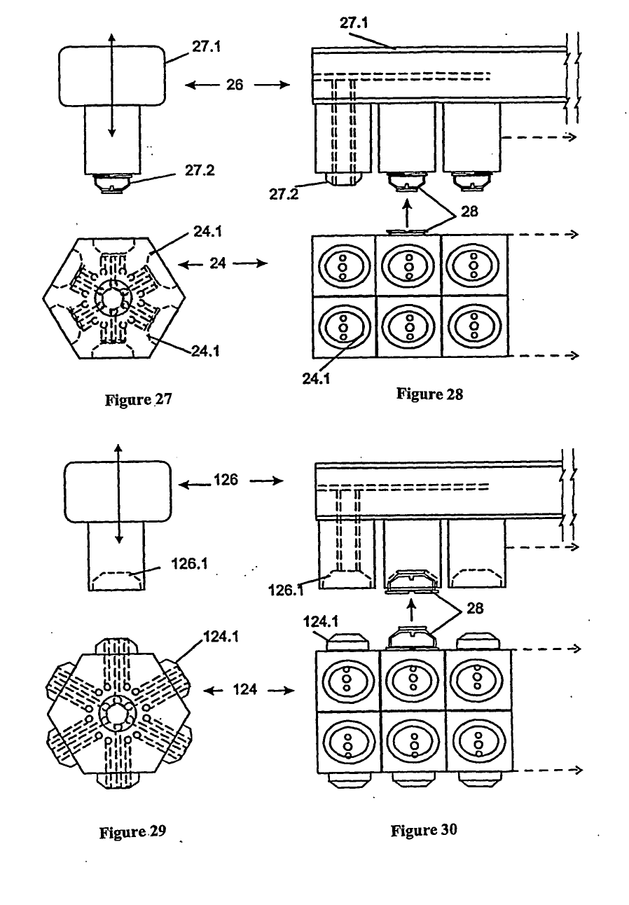

FIGS. 27 and 28 show end and side views, respectively, of the indexing and placing members of the apparatus of FIGS. 18 to 26;

FIGS. 29 and 30 show end and side views, respectively, of the indexing and placing members of a variant of the apparatus of the third aspect of the invention;

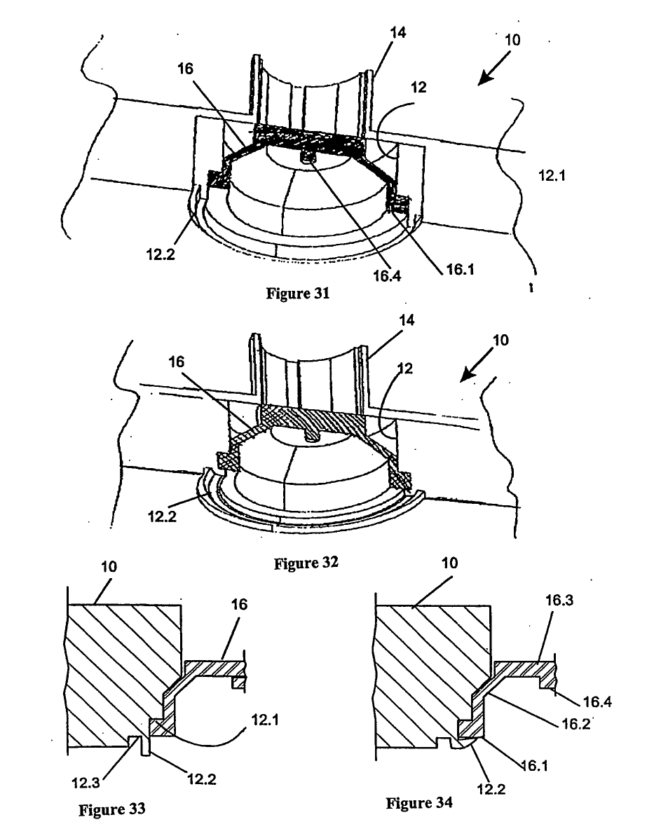

FIG. 31 shows a perspective, sectioned side view of a portion of a keyboard housing fitted with an elastomeric biassing member;

FIG. 32 shows a view similar to that of FIG. 31 with the elastomeric biassing member trapped in the keyboard housing;

FIG. 33 shows an enlarged scale side view section of a portion of FIG. 31;

FIG. 34 shows an enlarged scale side view section of a portion of FIG. 32;

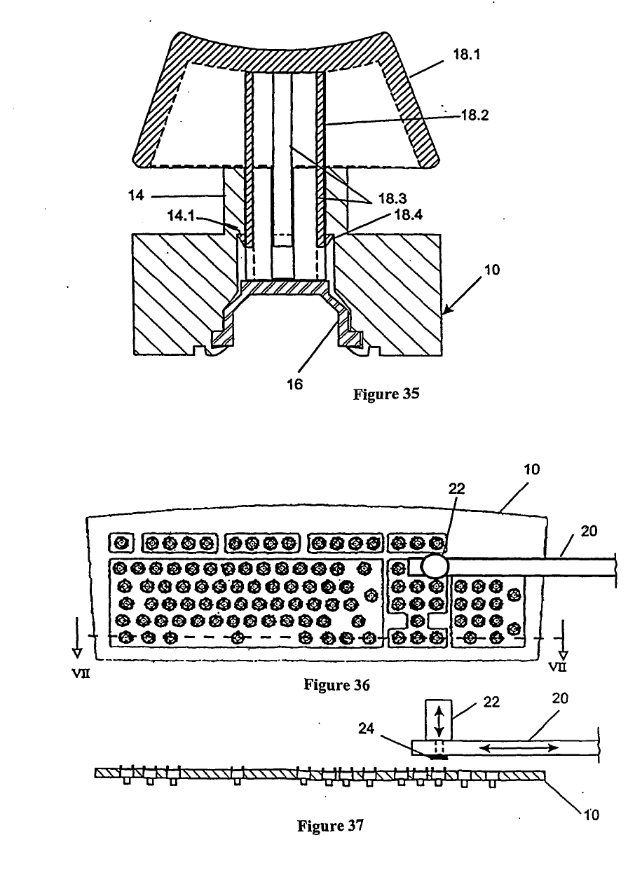

FIG. 35 shows an example of a keycap engaged with the housing;

FIG. 36 shows a plan view of a keyboard housing having a plurality of recesses each fitted with an elastomeric biassing member;

FIG. 37 shows a section along VII-VII of FIG. 35;

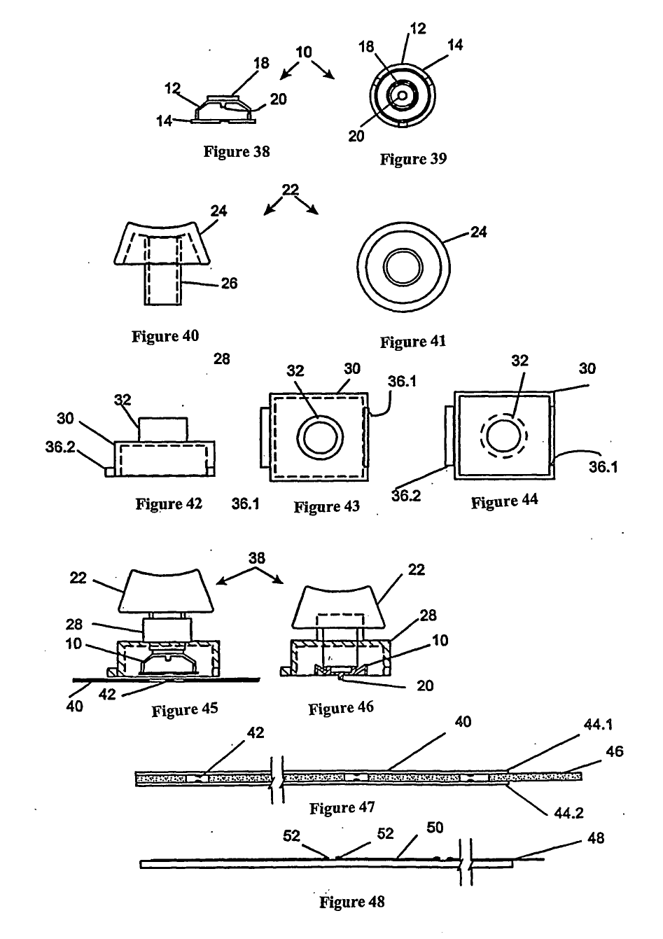

FIGS. 38 and 39 show side and plan views of an example of a domed elastomeric member for a switch component of the fifth aspect of the invention;

FIGS. 40 and 41 show side and plan views of an example of a keycap or button for a switch component of the fifth aspect of the invention;

FIGS. 42 to 44 show side, plan and underplan views of an example of a housing for a switch component of the fifth aspect of the invention;

FIGS. 45 and 46 show partly sectioned side views of an assembled switch component according to an exemplary embodiment of the fifth aspect of the invention, the button being shown in relaxed and depressed positions respectively;

FIG. 47 shows a sectioned side view of a portion of a contact membrane;

FIG. 48 shows a side view of a portion of a printed circuit board with spaced contacts;

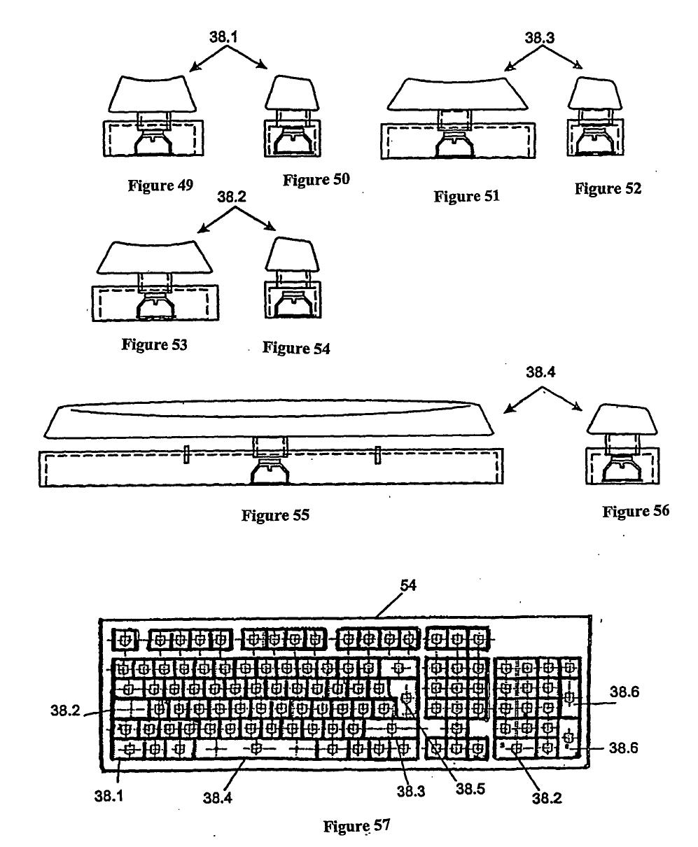

FIGS. 49 to 56 show schematic side and end views, respectively, of differently sized switch components according to exemplary embodiments of the fifth aspect of the invention, suitable for assembling of a keyboard;

FIG. 57 shows a schematic plan view of a keyboard according to an exemplary embodiment of the fifth aspect of the invention;

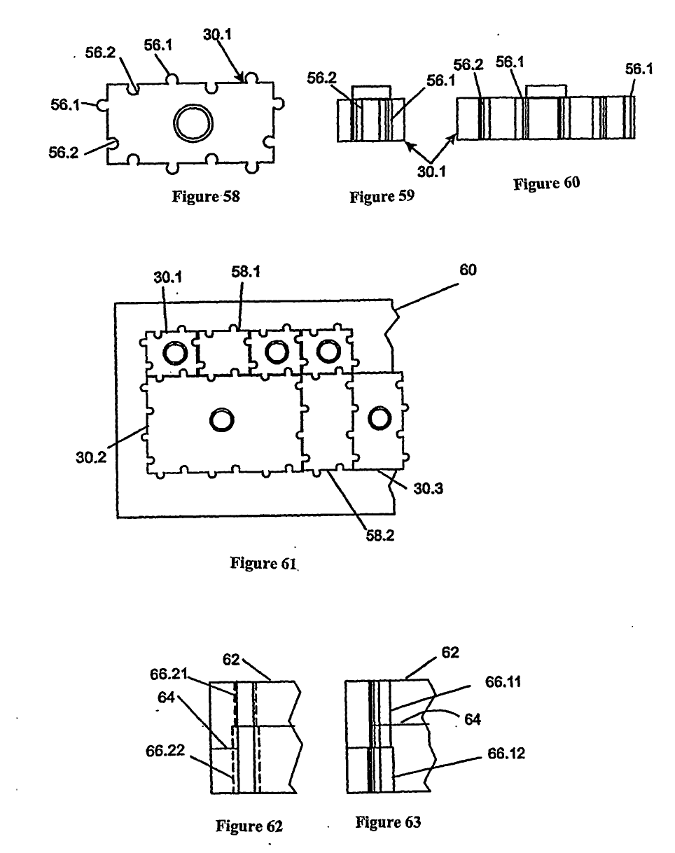

FIGS. 58 to 60 show plan, end and side views, respectively, of a switch housing provided with interlocking formations;

FIG. 61 shows a plan view of a portion of a keypad according to an exemplary embodiment of the fifth aspect of the invention, formed using switch housings of FIGS. 58 to 60;

FIGS. 62 and 63 show, respectively, end view of a switch, illustrating an example of inter-engaging formations for connecting adjacent switches to each other;

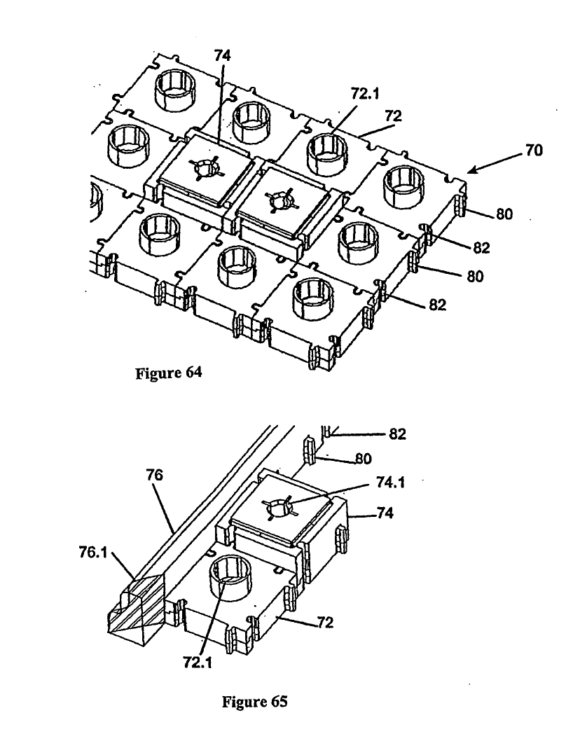

FIG. 64 shows a portion of a keypad formed using similarly sized switches and blank housings;

FIG. 65 shows an edge portion of the keypad of FIG. 64 and a side strip for finishing of the keypad;

FIGS. 66 to 68 show, respectively, side, plan and perspective views of a blank housing for the keypad of FIG. 64;

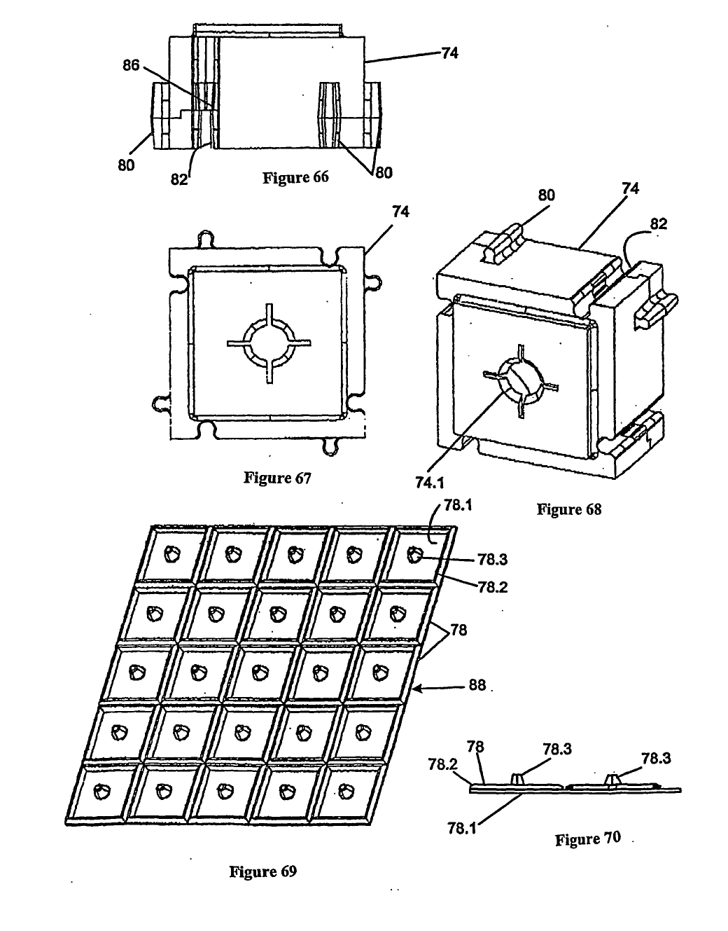

FIG. 69 shows a moulded cover element array from which cover elements can be separated; and

FIG. 70 shows a partly section side view of a portion of the array of FIG. 69.

FIGS. 1 to 7

FIGS. 1 and 2 show a portion of a string 10 of domed members or domes 12 connected to one another by connecting strips 14. The string is moulded of an appropriate resilient silicone rubber or other suitable elastomeric plastics. The domes are used to bias keyboard keys away from a switch or contact membrane, not shown. The specifics of the domed members are not significant to this invention, but for completeness, each dome has base 16 that will rest on a switch membrane, a hollow body 18, and a contact striker finger 20. The base 16 is formed with three lateral vents 16.1 to permit air to escape when the key is pressed in use. FIGS. 3 and 4 show another form of domed member 10.1 that corresponds generally to the shape of domed members used in a current keyboard. Member 10.1 has a hollow body 18 with a flat top 18.1 against which a key cap can rest, a conductive graphite pill 20.1 for activating a switch or bridging two spaced contacts, and a plurality of pimples 16.2 for venting air in use. While not shown, domes may alternatively be provided with a conductive coating on the striking finger 20.1.

The silicone rubber domes, when interconnected, can be easily, quickly and reliably stored, manipulated, gripped and so on by placing machines for assembling a keyboard. This contrast with individual separate domes which rest haphazardly on a surface, bounce and change orientation when on a shaken surface, and deform easily when gripped. While it would also be convenient for automatic handling to attach the domes to a carrier strip, this is at least impractical with current technology, because the silicone rubber is smooth and inert or insensitive to adhesives and cannot be easily and reliably fixed or bonded to the carrier strip; in any event attaching the domes to a carrier strip would involve an extra step and extra cost. Forming the string of interconnected domes by moulding them integrally to each other provides the subsequent automating benefits in an inexpensive, single operation, quick manner.

FIG. 3 illustrates schematically a portion of an injection moulding machine 22 comprising a vertically arranged mould 24 attached to a heating and injecting machine 26, a moulded product advancing means 28, a string of moulded product 10 and a bin 30 for collecting the string in overlying loops 32. The mould 24 comprises a laterally movable female mould 24.1 and a fixed complemental male mould 24.2. A feed bore 24.3 is formed in the male mould through which mould material can be injected into the moulding cavities formed between the male and female moulds. A port 24.4 is formed in the female mould and communicate with a suction source through a tube 24.5. The advancing means 28 is movable across the face of the mould and is described in more detail below.

FIGS. 4 and 5 show the machine 22 in greater detail, illustrating the mould 24 and advancing means 28. The female mould 24.1 has a plurality of rows 34 of moulding cavities 36 interconnected by channels 38. The bottom channel 38 of each row is open to the edge of the mould. A portion of a channel 38.1 extends upwardly from each uppermost cavity. The male mould 24.2 is substantially complemental to the female mould, other than for needed moulding formations.

The advancing means 28 comprises a pair of parallel slides 40 supported on either side of the mould 24 and a movable suction bar 42 extending parallel to the face of the mould and supported on the slides 40 by bushes 44. The suction bar has suction cups 46 that communicate with the suction bar and a source of vacuum, not shown, through a tube 48. The suction bar has a stand-by position 50 above the mould 24 where it is positioned during the moulding cycle, a pick up position 52 where the suction cups align with the top most row of mould cavities, and a drop off position 54 where the suction cups align with the bottom most row of mould cavities. The slides 40 are movable in a direction normal to the face of the mould.

In practice, the machine operates as follows. The suction bar is moved to its stand-by position 50, the mould is closed and a first length of interconnected domes is moulded in a known cycle of heating, injecting and cooling. The mould is then opened by moving the female mould away from the male mould, the first length of domes remaining at rest in the female mould either by the configuration of the mould or by suction. The suction bar is lowered to position 52 to align with the top row of cavities and then moved to bring the suction cups against the domes. Suction is applied to the cups to engage the domes and the suction bar moved away from the mould to free the length of moulded material, any suction applied to hold the lengths on the mould be removed at this stage. The suction bar is then moved down to position 54 to align with the last row of cavities and the top row of moulded domes then positioned in the last row of cavities. Suction is applied through the mould again and the suction through the suction bar released, whereafter the suction bar is moved to its stand-by position 50 and the moulding cycle repeated. During this moulding cycle the hot plastic mould material welds or fuses with the connecting pieces of the moulded lengths of domes from the previous moulding cycle.

The above procedure applies to all shapes of dome. As mentioned above, it is also possible for the domes to have a conducting graphite or coated striking finger. Such conductive fingers may be produced in a variety of ways, such as by so called “insert moulding” in which an insert is placed in each moulding formation either by mechanical placing or by intermediate injection prior to moulding a length or by “printing” after a length has been moulded.

The first aspect of the invention is not limited to the precise details described above and shown in FIGS. 1 to 7 of the drawings. Modifications may be made and other embodiments developed without departing from the scope of the invention. For example, while FIGS. 5 to 7 and the related description refer to the moulded members being retained on the female mould, they may be retained on the male mould and either the male or female mould may be movable as desired.

FIGS. 8 to 17

FIGS. 8 to 10 show a placing apparatus 10 for placing elastomeric domes 12 in a perforated sheet 16 that positions the domes in a keyboard housing 18. The domes 12 are moulded to be integrally joined to one another by connecting pieces 13 to form continuous string 14 of indefinite length as shown in FIGS. 14 and 15. The apparatus comprises a conveyor 20, a support arm 22, a placing head 24 mounted on the support arm, a movable mounting 26 for the supporting arm, and string support means 28.1 and 28.2 for supporting the string 14 in a path from a receptacle 30 to the placing head.

The conveyor 20 forms part of an assembly line that progresses keyboards or keyboard housings.

The support arm 22 is supported on the movable mounting 26 such that it can move forwards and backwards in the direction of its length in order to position the placing head over appropriate keys in a row. Suitable linear actuators, not shown and as are known in the art, are provided for moving the arm in steps of desired spacing over the keyboard to cove a row of keys and then rapidly back to a rest position. This is left and right movement in FIG. 2 and is referred to as the “X-axis”.

The movable mounting 26 is mounted on slides 26.1 to move perpendicularly to the X-axis arm and is moved by suitable linear actuators to align with desired rows of the keyboard. This is shown as up and down movement in FIG. 2 and is referred to as the “Y-axis”.

The placing head 24 can move up and down to place domes in the perforated sheet. The movable mounting is also movable vertically to adjust for different heights of keyboard, domes and the like. This vertical direction is indicated by two arrows in FIG. 1 and is referred to as the “Z-axis”.

The string support means 28.1 is a freely rotatable pulley mounted on an inclined arm 29. The string support means 28.2 is a similar pulley mounted on a frame portion of a stand for the receptacle 30.

The receptacle 30 is a plurality of narrow boxes, or a box formed with a plurality of narrow compartments in which a long length of string 14 is stored in an overlying loop or snake pattern.

The placing head 24, as best seen in FIGS. 10 and 11, comprises a support plate 32, spaced guide pins 34 secured to the plate and slidably in bushes 36 in the support arm, a pneumatic piston and cylinder assembly 38 mounted on the support plate and carrying a knife 40, a pneumatic piston and cylinder assembly 42 also mounted on the support plate and having a pushing head 44 and a hexagonal indexing member 46 rotatably mounted on the support plate.

Two further pneumatic piston and cylinder assemblies 48 mounted on the support arm are provided for moving the placing head towards and away from the support arm, i.e. up and down along the Z-axis.

The indexing member 46 is provided with an engaging member or mushroom head 50 on each of its six faces, each head 50 being shaped and dimensioned to fit closely into a rubber dome 12. A central port 52 is formed in each head and communicates with a vacuum source, not shown, via an annular gallery 54 and a feed line 56. Two offset ports 58 are also formed in each head to either side of port 52. The ports 58 are arranged to communicate with a pressure source, not shown, via a feed line 62 through a manifold 60 when the head is in its lowermost position. A hole 64 is formed in the support arm for feeding the domes to the indexing member.

In practice the apparatus operates as follows. The arm 22 is moved to its rightmost position, clear of the path along which keyboards move on the conveyor. A string 14 of joined, integrally moulded rubber domes is fed from the receptacle, over the pulleys 28, through the hole 64 in the arm to the indexing member. The last dome is fitted onto the appropriate mushroom head and vacuum applied to hold the dome on the head.

The assembly line and apparatus are then activated to move a keyboard to a suitable position in line with the arm. The term “keyboard” now refers to the perforated sheet and an upper keyboard housing part that supports it, the housing being inverted on the conveyor. The arm 22 is moved to position the placing head over the first key in the first row of the keyboard when a sensor, not shown, senses a keyboard is in its correct position. The indexing member is rotated one step by activating the assembly 42 to move the first dome beyond the knife 40, whereafter assembly 38 is activated to cut the material between two domes. The indexing member is then indexed a further step by assembly 42 to bring the first dome into register with the first perforation in the first row. The placing head is then moved down to position the dome in the first perforation. A blast of air is then pumped into the mushroom head positively to eject the dome.

The placing head is then moved up and the arm extended to bring the head into line with the next perforation and the process repeated, the indexing member being rotated in steps and the domes being fed and separated appropriately at each step. When a dome has been placed in each desired perforation in the row, the arm shoots back to its rest position. The arm is then moved laterally to the next row of keys and the process repeated and so on until a dome has been fitted into each desired perforation of the sheet 16. A logic controller controls the extension and positioning of the arm to suit the arrangement of the keys in each row. Another logic controller controls the lateral movement of the arm to accommodate the relative spacing or pitch between rows of keys in a keyboard.

It is also possible to place the domes by moving left along one row and then backwards or right along the next row, the arm being moved laterally at the end of each row.

FIG. 12 shows a multiple placing head apparatus 70 with eight supporting arms 22, each carrying a placing head 24 as described above. In this event, each arm and head is aligned with and places domes in one row of the keyboard. In use, the arms and heads operate at the same time, independently of the other arms and heads. Each arm and head starts at its rightmost position and progresses at a speed dictated by the number of domes to be placed in its row. When the row has been completed the arm shoots back to its rest position and waits until all the arms have completed their tasks and returned to the rest position. The next keyboard is then moved into position. The drawing shows two arms that have completed their tasks, the remaining being shown at intermediate positions.

FIG. 13 shows a single placing head apparatus 80 used with amovable keyboard bed 82. The apparatus 80 comprises a placing head 24 mounted on a supporting arm 22 as described above, a guide 84 on which the arm is slidable and a piston and cylinder assembly 86 for moving the supporting arm. The keyboard bed 82 comprises a table 88, abed 90 slidably mounted on the table via guides 92, and piston and cylinder assemblies 94 for moving the bed. In use, a keyboard is placed on the bed, the apparatus activated to place domes along the first row of keys, the bed moved to align the next row of keys with an arm, the apparatus activated to place domes along the next row of keys, and so on.

FIGS. 16 and 17 show schematically another form of indexing member 46.1 that is also hexagonal and is formed with six recesses to receive domes 12. Three ports, namely a central vacuum pressure port 52.1 straddled by two positive pressure ports 58.1 are formed in each recess and communicate with appropriate pressure and vacuum sources as described previously. In use, vacuum is applied to hold the domes in the recesses and pressure applied to eject the domes when required. The domes are separated from the string by a knife, not shown, at a suitable stage. In this event the apparatus is used to place the domes, base side down, at appropriate locations on a contact membrane 100. A suitable adhesive may be applied to hold the domes in position on the membrane—the adhesive may be applied to the membrane and/or to the domes as desired.

The second aspect of the invention is not limited to the precise details described above and shown in FIGS. 8 to 17 of the drawings. Modifications may be made and other embodiments developed without departing from the spirit of the invention. For example, instead of fitting the domes to keys, the domes may be adhered to a contact membrane using a suitable adhesive, whereafter an upper keyboard housing is fitted over the membrane and domes, etc. The adhesive may be applied to the membrane or adhesive may be applied to the underside of each dome. The latter is accomplished using an adhesive supply fed through a supply line that communicates with suitable ports formed in the indexing member.

Certain examples described above refer to a “perforated sheet 16”, which is typically a Mylar sheet formed with an array of holes corresponding to key positions and is used in some keyboards. In this event, each dome is placed in a hole with its base flange resting on the periphery of the hole. Other keyboards use a Mylar sheet or a more substantial plastics moulding formed with an array of recesses. Each recess is shaped to receive a dome and has a central hole through which a post of a key can pass. In this event, each dome is placed in a recess in the same way as described in the examples.

FIGS. 18 to 30

FIGS. 18 and 19 show a placing assembly 10 for placing elastomeric domes in an array of spaced rows for assembling computer keyboards. The assembly comprises eight spaced placing apparatuses 12 and a convey 14 that has spaced receptacles 16 for moving keyboard housing parts 18 in steps into alignment with each apparatus 12. Each apparatus places one selected row of domes for a keyboard when the keyboard part aligns with the apparatus.

FIGS. 20 and 21 schematically illustrate the placement of rubber domes for two different keyboard layouts 20.1 and 20.2, respectively. Keyboard 20.1 has seven rows of domes, five rows corresponding to a standard “qwerty” layout and spacing and two rows at different spacings for function keys and quick access multimedia/Internet specific keys. Keyboard 20.2 has six rows of domes for a standard keyboard with a “qwerty” layout, one row of function keys, a set of navigating keys and a numeric keypad. The functions and arrangements of the keyboards is not pertinent, but it is significant that the spacings between rows varies and the arrangement and spacing of domes/keys in each row also varies.

FIGS. 22, 25 to 28 show a placing apparatus 12 comprising a frame 22 that supports a rotatable elongate indexing cylinder 24 and a slidable transfer bar or pick up head 26. The apparatus places a row of rubber domes 28, each separated from a string 30 of integrally moulded domes, on a keyboard part 18, such as a positioning sheet or moulded body formed with perforations or recesses for receiving and positioning the domes.

Side and plan view of the string 30 of elastomeric domes 28 connected to each other by connecting strips 29 are shown in FIGS. 23 and 24.

The transfer bar 26 is shown in two positions, namely 26.1 for receiving domes from the indexing cylinder and 26.2 for depositing domes on a keyboard. The transfer bar shoots between the two positions under the action of jets of air or a fast acting piston and cylinder assembly.

The indexing cylinder 24 is in the form of a hexagonal cylinder, each face of which has a row of spaced recesses 24.1, only some of which are shown, and is rotated in steps by a suitable motor 24.2. A pair of vacuum ports 24.3 and a pressure port 24.4 are formed in each recess 24.1, the ports being supplied with low and high pressure through longitudinally extending manifolds and sliding seals, not shown because of the relatively small scale of the drawing.

Suitable control valves, not shown, are provided to control the vacuum and pressure supplied to the manifolds.

The transfer bar 26 has a body 27.1 with a row of heads 27.3, each for receiving a dome. Each head 27.2 has vacuum and pressure ports with an appropriate manifold and supply source 27.4 and 27.5. A pneumatic piston and cylinder assemblies 27.3 moves the transfer bar between an upper and a lower position, the transfer bar being slidably guided on shafts.

In use, a required number of strings 30 is fed from a receptacle, not shown, upwardly to an appropriate position along the indexing cylinder, the position corresponding to the intended position at which a dome is to be placed on the keyboard part. The indexing cylinder engages a row of domes at an initial position, then rotates one row and engages the next row of domes. Vacuum is applied to each recess to hold the domes in the recess for a portion of the rotational path of the head. After the next rotational step a knife, not shown, severs the connections between adjacent domes to separate them. The knife may move along the indexing bar to slice through the connecting pieces or may move radially into the indexing bar to cut the connecting pieces. The next rotational step brings the row into register with the transfer bar. At this stage the assemblies 27.3 move the transfer bar down so that the heads on the transfer bar seat in the recesses of the domes on the indexing cylinder. The vacuum in the indexing cylinder is removed and pressure applied to eject the domes; simultaneously vacuum is applied to the heads of the transfer bar to retain the domes on the heads. The assemblies 27.3 then move the transfer bar to its upper position, whereafter it is shot across to position 26.2 above the keyboard part. The transfer bar is then moved down, the vacuum released and pressure applied to eject the domes from the heads and set them in the positioning sheet or moulded body. The transfer bar then returns to position 26.1 to receive the next row of domes. When this happens, the conveyor is indexed to move the keyboard part to the next station.

FIGS. 29 and 30 show a variant of the indexing member 124 and transfer bar 126. In this event the indexing member 124 is provided with heads 124.1 for fitting into domes, while the transfer bar 126 is formed with recesses 126.1 to receive domes. Other than these changes, this arrangement functions in much the same way as the embodiment described above. This arrangement is used to place the domes, base down, on a contact switch membrane. Adhesive to hold the domes in place on the membrane may be applied to the membrane or to the bases of the domes using any suitable, appropriate means.

It can be seen from the foregoing that individual domes can now be handled and fed to an automated placing machine or robot in a quick and reliable manner. The machine or robot can quickly and reliably place the individual domes in any desired array. The domes can be placed base down or domed side down as desired. This apparatus can be used for fast assembly of individual domes for any keypad, keyboard and the like.

The third aspect of the invention is not limited to the precise details described above and shown in FIGS. 18 to 30 of the drawings. Modifications may be made and other embodiments developed without departing from the scope of the invention.

FIGS. 31 to 37

FIGS. 31 to 34 show a section through a portion of a housing 10 of a keyboard. The housing 10 is formed with a circular recess 12 and a guide hub 14 co-axial with the recess. A domed elastomeric member or dome 16 of appropriate rubber, such as silicone, is received in the recess 12. In FIGS. 31 and 33 the dome is loose, while in FIGS. 32 and 34 the dome is trapped.

While not shown, the housing is formed with an array of recesses and hubs corresponding to the keys of a keyboard as shown in FIGS. 35 and 36.

Each recess 12 is formed with a shoulder or land 12.1 and a lip 12.2 at the outer edge of the land. The lip projects above the level of the housing and is separated from the housing by a recess 12.3.

The dome 16 has a base rim or flange 16.1, a tapering body 16.2, a flathead 16.3 at the top of the dome and a central contact actuating pin 16.4. The shape of the head varies in practice according to manufacturer's desires and may, for example, have a lip for positioning or stabilising a post of a keycap. The pin 16.4 is provided for actuating the contacts of a contact membrane when a keycap is depressed. The rim 16.1 is thickened relative to the rest of the dome and seats on the land 12.1.

The dome is secured to the housing by heating the rim 12.3 and bending it inwards over the rim 16.1 of the dome as best seen in FIGS. 32 and 34. This also has the effect of sealing the dome to the housing.

The sealing of the domes to the housing enables a spillproof keyboard to be formed. The keyboard can be made to be waterproof by providing additional sealing, such as sealing the contact membrane, forming seals between the housing and contact membrane, and waterproofing other electrical and electronic components and connectors as required.

FIG. 35 also shows a keycap 18 engaged with the housing and dome. The keycap has a hollow head 18.1, a longitudinally split tubular post 18.2 and tags 18.3 with locking formations 18.4 formed as part of the post. The tags clip under a radially inwardly extending land 14.1 formed at the base of the hub 14.

FIGS. 36 and 37 show part of a machine for heating and deforming the lip 12.2. The machine includes an arm 20 that can move sequentially along each row of recesses of the housing 10 and a deforming device 22 supported on the arm. The device 22 includes a heating and deforming head 24 connected to a pneumatic actuator 26 that can move the head up and down as indicated. As best seen in FIG. 37, the machine has moved along the first row of the housing and deformed the lips 12.2 of some of the recesses to lock the domes in those recesses.

The further aspect of the invention is not limited to the precise details described above and shown in FIGS. 31 to 37 of the drawings. Modifications may be made and other embodiments developed without departing from the scope of the invention. For example, the housing may be for a single switch instead of multiple switches as described above. The elastomeric member need not be a dome, but can be any suitable shape. Also, instead of a single arm and deforming head as shown in and described with reference to FIGS. 36 and 37, the deforming head may be shaped and sized to span all the recesses of a keyboard or other keypad, so that all the elastomeric members can be trapped and, optionally, sealed at one time.

For making individual switches, a plurality of switch housings may be aligned in a row adjacent to one another, a row of elastomeric members placed in the switch housings and then a suitable constructed deforming head applied substantially simultaneously to deform selected portions of the row of switch housings.

FIGS. 38 to 70

FIGS. 38 and 39 show a domed elastomeric member 10 of appropriate rubber, such as silicone, commprising a dome 12 with a base rim or flange 14, an annular positioning rib 18 at the peak of the dome and a contact actuating pin 20.

FIGS. 40 and 41 show a keycap or button 22 for a keyboard comprising a hollow head 24 and a tubular post 26 extending from the inside of the head.

FIGS. 42 and 44 show a rectangular housing 28 having a body 30, a guide bush 32 on the body, an internal step 36.1 on one side of the body and an external step 36.2 on the other side of the body. The steps 36 are provided for laterally interlocking adjacent housings to each other.

FIGS. 45 and 46 show an assembled switch 38 of the invention comprising a dome 10, a keycap 22 and a housing 28. FIG. 45 shows the switch resting on a contact membrane 40 having opposed contacts 42. FIG. 46 shows the keycap depressed to cause the pin 20 of the dome to project beyond the bottom of the housing and push the contacts 42 against each other.

FIG. 47 shows the contact membrane 40 in greater detail from which it can be seen that it is composed of an upper layer 44.1 of contacts 42, each connected by a printed conductor, not visible, to a suitable multi-port terminal connector, a similar lower layer 44.2, and a sheet of foamed rubber 46 sandwiched between the layers. The foam biases pairs of contacts away from each other.

FIG. 48 shows a printed circuit board 48 with conductors 50 and pairs of laterally spaced contacts 52. When the switch is used with the board 48, the pin 20 of the dome is provided with a conductive coating or cover member for electrically bridging the contacts 52 as known in the art.

FIGS. 49 to 57 show a selection of differently sized switches 38.1 to 38.6 shaped as various forms of keys for making a keyboard 54. The numbered keys of the keyboard shown in FIG. 57 correspond to the same numbered keys of FIGS. 49 to 56.

FIGS. 58 to 60 show a rectangular housing 30.1 for a switch, the housing being formed with interlocking round cylindrical rib 56.1 and substantially complementary groove 56.2 formations on its side faces. The formations 56 may side one into the other or may clip laterally into each other, depending on the material of the housing. FIG. 61 shows how housings 30.1, 30.2, 30.3 of different shapes and size may be connected to one another to form a keypad 60, such as for a process controller. Blank housings 58.1, 58.2, etc. are used to fill unneeded spaces between switches and solidly to lock all switches in place.

FIGS. 62 and 65 show portions of another example of switch housing 62 of moulded plastics. The housing has a mould split line 64 and is provided with rib 66.1 and groove 66.2 formations that engage similar complementary formations on an adjacent switch housing. As shown a portion 66.11 of each rib is narrower in cross-section than the remaining portion 66.12. Also a portion 66.21 of each groove is narrower in cross-section than the remaining portion 66.22. The steps between the relatively narrower and wider portions is formed as sharp shoulders and are formed along the split line 64, which is not planar but formed as a plurality of steps. With this arrangement adjacent housings can be engaged with one another in one direction, but are inhibited from being disengaged by the narrower portions and shoulders. The arrangement of the narrower and wider portions is such that adding additional housings is relatively easy but when engaged, the housing lock one another in place.

FIGS. 64 to 70 show various components for forming another example of keypad 70. The components are switch housings 72, blank housings 74, elongate side or frame members 76, and cover plates or elements 78.

As best seen in FIGS. 64 and 65, the switch housings 72 have central hubs 72.1 for guiding and supporting buttons, not shown. The blank housings 74 are higher than the switch housings and are formed with central locating holes 74.1 in their upper surfaces. The housings interengage one another via rib 80 and groove 82 formations and also engage the side strips 76 by similar rib 80 and groove 82 formations. The side strips are made into a frame by mitreing the corners as shown at 76.1.

Referring to FIGS. 66 to 68, the blank housings 74 are hollow blocks that are square in plan view. Each groove extends the full height of the housing and has a double taper restriction 82.1 at its bottom region. Each rib 80 extends a part of the height of the housing, the height corresponding to the relatively lower height of the switch housing body. The ribs also have a double taper as shown. The double tapers merge or transition at mould split lines 86, with the heights of the transitions being different as best seen in FIG. 66. These ribs and grooves lock to each other to prevent undesirable disengagement.

FIGS. 69 and 70 show the cover plates 78 formed as a sheet 88 of an array of such cover plates. Each cover plate has a square web 78.1, a peripheral wall 78.2 and a headed locking pin 78.3. In use a plate is cut from the array 88 and then engaged with a blank housing 74 by locking the pin 78.3 in the hole 74.1 of the housing.

When assembled the height of the side strips correspond to the height of the blank housings provided with cover plates, while the height of the buttons of the switches stands proud to a desired extent above the height of the side strips and blanks.

It will be appreciated that the constructions described above and shown in the drawings provide reliable, inexpensive switches that can be tailored for feel and characteristics. Also such switches may be easily and quickly assembled into keypads or desired arrays. This assembly may be done manually, but the components are also suitable for mass production using automated assembly machines or robots. Thus, for example, several thousand keyboards for laptop computers can be made up using these switches.

The fifth aspect of the invention is not limited to the precise details described above and shown in FIGS. 38 to 70 of the drawings. Modifications may be made and other embodiments developed without departing from the scope of the invention.

1. An arrangement comprising a plurality of resiliently flexible biasing members that are joined directly to one another, in a substantially side-by-side configuration to form a continuous, flexible string of said biasing members.

2. An arrangement according to claim 1, wherein the resiliently flexible biasing members about one another.

3. An arrangement according to claim 1, wherein the resiliently flexible biasing members are inter-connected by integral connecting pieces.

4. An arrangement according to claim 1, wherein the biasing members are of a substantially dome-like configuration.

5. An arrangement according to claim 1, molded of an elastomeric material, such as resilient silicone rubber.

6. A method of making an arrangement of a plurality of resiliently flexible biasing members that are joined directly to one another, the method comprising the steps of:
(a) molding a first length of interconnected biasing members in a mold having a plurality of adjacent molding formations interconnected by connecting passages arranged in a line, there being a first formation at one end and a last formation at the opposite end of the line, with a first biasing member being formed in the first formation;
(b) removing said first molded length, advancing it relative to the mold until the first biasing member registers with the last formation of the mold, and inserting the first member in said last formation; and
(c) molding a second length of members, the first member of said first length being caused to be joined to said second length of members.

7. Apparatus for making an arrangement of a plurality of resiliently flexible biasing members that are joined directly to one another comprising:
(a) a mold having a plurality of molding formations interconnected by connecting passages and arranged in a line for molding a length of interconnected biasing members, there being a first formation at one end and a last formation at the opposite end of the line;
(b) gripping means for releasably engaging a biasing member molded in said first formation; and
(c) progressing means for moving the gripping means between said first and last formations in order to remove a biasing member formed in said first formation from said first formation, advance said biasing member along the length of the line and position it in the last formation of the mold.

8. Apparatus according to claim 7, wherein the mold includes male and female parts that form a molding formation when the parts are brought together.

9. Apparatus according to claim 8, wherein the mold is configured to releasably retain a molded length on one of the parts, the first member being removed from and inserted in or onto the same mold part.

10. Apparatus according to claim 8, wherein means is provided to releasably retain a molded length on one of the parts, the first member being removed from and inserted in or onto the same mold part.

11. Apparatus according to claim 10, wherein said means for releasably retaining said mold length comprises suction means.

12. Apparatus according to claim 8, including means for holding the first member in or on an appropriate part of the last molding formation.

13. Apparatus according to claim 12, wherein said holding means comprises or includes suction means.

14. Apparatus according to claim 13, wherein a port is provided in the mold part formation and means are provided for applying suction to the port.

15. Apparatus according to claim 7, wherein said gripping means uses suction to grip the members.

16. Apparatus according to claim 7, wherein the progressing means is arranged to reciprocate the gripping means between the first and last formations.

17. Apparatus according to claim 7, wherein said progressing means includes an endless loop provided with a desired number of gripping means that advance in steps from the first to the last formation.

18. Apparatus according to claim 7, wherein the includes a plurality of adjacent lines of interconnected molding formations and the gripping means is constructed so as to releasably engage a member molded in the first formation of the or each line.

19. Apparatus according to claim 18, wherein the mold is arranged such that the line of interconnected molding formations extends substantially vertically in use.

20. Apparatus according to claim 19, wherein in use, the molded lengths that have been removed from the mold hang below the, with the member molded in the first formation engaged in the last formation of the mold for the next molding operation.

21. Apparatus according to claim 7, wherein the connecting passages form connecting pieces between the molded members.

22. Apparatus according to claim 21, wherein a portion of a connecting passage is formed in the extending away from the first molding formation.

23. Apparatus according to claim 7, wherein the continuous flexible string of molded biasing members is wound onto a suitable spool, or placed for storage, in overlying lengths of strips in a deep narrow receptacle.

24. A method of placing a component on a body using a placing head, the component being one of a string of components integrally joined to one another, the method including the steps of:
feeding the string to the placing head;
engaging at least the last component at a free end of the string with the placing head;
positioning the placing head at the desired position with respect to the body;
releasing and placing the last component on the body; and
cutting the string to separate the last component from the string.

25. A method according to claim 24, wherein the string is cut prior to releasing and placing the last component on the body.

26. A method according to claim 24, including the step of moving the placing head and body relative to each other sequentially to each desired position where a component is to be placed.

27. A method according to claim 26, wherein movement of the placing head and body relative to each other is effected by moving the placing head while the body is stationary, or moving the body while the placing head is stationary, or moving both the body and placing head.

28. A method according to claim 27, wherein movement of the placing head and body relative to each other is effected by at least moving the placing head, and the method includes the steps of moving the placing head and placing the components in a first row along the body, moving the placing head to align with the next row and placing the components in the next row, and so on.

29. A method according to claim 24, including the steps of providing a plurality of adjacent placing heads, each head being arranged to align with one row, and moving each placing head to place the components along its respective row.

30. A method according to claim 29, including the step of moving said placing heads in unison to enable one or several components to be placed at substantially the same time, depending on the relative alignment of the components in the respective rows.

31. A method according to claim 29, including the step of moving said placing heads independently of one another, each head placing a component at a desired position along its row.

32. A method according to claim 31, in which the components are placed sequentially in each row.

33. A method according to claim 32, wherein each placing head returns to a starting position at one end of the body before placing each row of components.

34. A method according to claim 29, including the steps of returning each placing head to the starting position when it has completed placing components in its respective row, and thereafter moving the next body into position in relation to the placing heads.

35. Apparatus for placing a component on a body, the component being one of a string of components:
a placing head including engaging means to releasably engage at least the last component at the free end of the string, cutting means to separate the last component from the string, and actuating means to place the separated last component on the body;
a movable support member supporting the placing head;
support moving means for moving the support member from a starting position to an end position and back again in a first direction; and
string support means to support the string in a path from a receptacle to the placing head.

36. Apparatus according to claim 35, wherein the engaging means includes a component bearing formation and a port to supply air at pressure to the bearing formation.

37. Apparatus according to claim 36 in which control means is provided to selectively apply low pressure (vacuum) to hold the component on the bearing formation.

38. Apparatus according to claim 37, wherein the control means also applies high pressure to positively release the component from the bearing formation.

39. Apparatus according to claim 35, in which the supporting member is movable along a second direction perpendicular to the first direction, such that components can be placed in a desired number of parallel rows.

40. Apparatus according to claim 35, further including a plurality of supporting members, each provided with a placing head, each for placing a row of components in the first direction.

41. Apparatus according to claim 35, wherein the placing head comprises an indexing member provided with a plurality of engaging means, the indexing member being movable to progress the engaging means in an endless path that intersects the path of the string and has a portion adjacent to the body at a position where a component is to be placed.

42. Apparatus according to claim 41, wherein the indexing member is rotatable, cylindrical body, with a plurality of engaging means being provided around the periphery of the body.

43. Apparatus according to claim 41, wherein the indexing member is an endless band supported on at least two spaced rollers, the engaging means being provided on the band.

44. A placing head for placing a component on a body, the component being one of a string of components integrally joined to one another, the placing head comprising:
engaging means for releasably engaging at least the last component at the free end of the string;
cutting means for separating the last component from the string; and
actuating means to cause the separated last component to be placed on the body.

45. A method of placing components on a body, each component being one of a string of components joined to one another, the method including the steps of:
feeding a plurality of strings of components to a row of desired spaced positions along an elongate indexing member;
releasably attaching an end component of each string to the indexing member;
separating each end component from its respective string;
transferring the row of separated components from the indexing member to an elongate placing member, the components being releasably attached to the elongate placing member; and
transferring the separated components in a row from the placing member to the body;
each step being performed substantially simultaneously on all of the components in a row.

46. A method according to claim 45, including the step of retaining the strings in engagement with the indexing member, more preferably by releasably attaching at least the end and next-to-end components of each string to the indexing member.

47. A method according to claim 45, including the step of moving the indexing member from a first position to attach the end components to a second position to transfer the components to the placing member.

48. A method according to claim 45, including the steps of substantially simultaneously placing a row of components in a desired position on a plurality of bodies, advancing the bodies and placing a further row of components, and so on as required in order to place an array of spaced rows of components on each body.

49. Apparatus for placing components on a body, each component being one of a string of components joined to one another, the apparatus comprising:
an elongate indexing member, the indexing member having engaging means for releasably engaging at least one component of each string with an indexing member;
means for separating an end component from each string;
an elongate placing member, the, placing member having transfer means for releasably receiving components from the indexing member, and at least one of the indexing and placing members being movable to a position in which components can be transferred from the indexing member to the placing member; and
means for moving at least one of the body and the placing member to a position in which components can be transferred from the placing member to the body.

50. Apparatus according to claim 49, wherein the indexing member is an endless band.

51. Apparatus according to claim 49, wherein the indexing member is a cylindrical body.

52. Apparatus according to claim 51, wherein the indexing member rotates in one direction in steps in order to move components from an engaging position to a discharge position in which the components are presented to the placing member.

53. Apparatus according to claim 52, wherein the indexing member moves several steps between the engaging and discharging positions.

54. Apparatus according to claim 53, in which the last component may be separated from the string at any one of said several steps or positions.

55. Apparatus according to claim 49, wherein the placing member is movable from a received position in which it is adjacent the indexing member, to a depositing position in which it is adjacent the body.

56. A multi-stage placing assembly, comprising:
a plurality of placing apparatuses, arranged at spaced positions along a path; and
conveyor means to move bodies on which components are to be placed along the path;
wherein said placing apparatus comprises an elongate indexing member, the indexing member having engaging means for releasably engaging at least one component of each string with an indexing member; means for separating an end component from each string an elongate placing member the placing member having transfer means for releasably receiving components from the indexing member; and at least one of the indexing and placing members being movable to a position in which components can be transferred from the indexing member to the placing member; and means for moving at least one of the body and the placing member to a position in which components can be transferred from the placing member to the body.

57. An assembly according to claim 56, wherein the conveyor means is arranged to move the bodies in increments corresponding the positions of the plurality of apparatuses.

58. A switch comprising;
a button,
a housing,
a pair of contacts, and
an elastomeric member received in a recess in the housing for biasing the button away from the contacts, wherein the elastomeric member has a resilient body portion and a peripheral body rim around the body portion;
and wherein the switch further comprises, a clamp connected to or formed integrally with either the housing or the elastomeric member, for securing at least a portion of the rim to the housing to create a fluid-tight seal therebetween, said clamping means being movable between an open configuration in which said elastomeric member can be introduced into or removed from said recess and a sealed configuration in which said fluid-tight seal between said housing and said elastomeric member is created.

59. A method of assembling a switch comprising
providing a button, a housing, a pair of contacts and an elastomeric member having a resilient body portion and a peripheral body rim around the body portion,
introducing said elastomeric member into a recess in the housing, and
creating a fluid-tight seal between at least a portion of the rim and the housing.

60. A switch comprising
a button,
a housing, and
an elastomeric member received in a recess in the housing for biasing the button away from a pair of contacts, wherein the elastomeric member has a resilient body portion and a peripheral body rim around the body portion; and wherein the switch further comprises a device securing a portion of the rim to the housing to create a fluid-tight seal between the outer surface of the housing and the upper surface of the elastomeric member.

61. A mechanism for a switch comprising:
a housing; and
an elastomeric member received in a recess in the housing for biasing a button of a switch away from a pair of contacts, wherein the elastomeric member has a resilient body portion and a peripheral body rim around the body portion, and wherein the mechanism further comprises means, for securing the rim to the housing so as to create a fluid-tight seal between the portion of the recess in the housing surrounding the upper surface of the elastomeric member and the atmosphere in which the mechanism is located.

62. A switch according to claim 58, wherein the clamp is a separate component that is fitted into a region of the recess and engages the housing and the rim of the elastomeric member.

63. A switch according to claim 62, wherein said clamp is a force fit in the recess.

64. A switch according to claim 58, wherein the clamp is a portion of the material of the housing that has been deformed to extend over and engage the rim of the elastomeric member, or a portion of the material of the rim of the elastomeric member that has been deformed to engage an edge of the housing.

65. A switch according to claim 64, wherein the housing is formed with a suitably positioned lip member that is heated and deformed to extend over the rim of the elastomeric member.

66. A switch according to claim 62, wherein the clamping member engages the entire periphery of the rim or a portion thereof only.

67. A plastics housing for a switch according to claim 58, the housing comprising a body formed with a recess for receiving said elastomeric member, wherein said clamp comprises at least one rib formed around at least a portion of the recess, the rib being deformable to trap the elastomeric member in the recess thereby to create the fluid-tight seal therebetween.

68. A housing according to claim 67, wherein the housing is formed with an array of recesses, each of which is provided with a deformable rib.

69. A housing according to claim 67, wherein the rib extends around the entire periphery of the recess.

70. A method of assembling a switch according to claim 65, the method including the steps of:
fitting the elastomeric member into the recess; and
deforming a portion of the housing surrounding the recess to trap the elastomeric member in the recess.

71. A method according to claim 70, including the step of heating a portion of the housing surrounding the recess prior to deforming the material to tap the elastomeric member.

72. Apparatus for trapping an elastomeric member in a recess in a housing according to claim 58, the apparatus comprising a support arm, means to move the arm in a path, at least one deforming head, and means for moving the deforming head between a first position in which it is clear of the housing and a second position in which it is able to apply pressure to the housing.

73. Apparatus according to claim 72, comprising means for applying heat to at least a selected portion of the housing to facilitate deforming that portion.

74. Apparatus according to claim 73, wherein the heating means comprises the deforming head itself which is heated.

75. Apparatus according to claim 73, wherein the heating means comprises an inductive or radiant heating element on the head that is constructed to heat the selected region prior to moving the deforming head against the selected region.

76. A keypad including a plurality of switches, the keypad comprising a housing member formed with a row of recesses, a unitary resilient member received at least partly in at least one of the recesses, and a clamping means for each recess trapping the resilient member in the recess, thereby to create a fluid-tight seal between said resilient member and said housing member.

77. A keypad according to claim 76, wherein the resilient member is an elastomeric member.

78. A keypad according to claim 77, wherein each elastomeric member is sealed to the housing.

79. A keypad according to claim 74, further including a button or key cap for each switch, the button being slidably guided with respect to the housing, abutting the resilient member and having means keeping it in contact with the housing and the resilient member of each switch.

80. A keypad according to claim 79, wherein each button is provided with a post that is slidably guided in the housing and that abuts the resilient member in use.

81. A switch comprising a housing, a button and an elastomeric member substantially contained in the housing for resiliently biassing the button away from the housing, wherein the housing is configured to be directly connected, or otherwise directly joined to, one or more other housings.

82. A switch according to claim 81, wherein the button has an integral post that is slidably guided in the housing, the post being arranged to bear against the elastomeric member.

83. A switch according to claim 81, wherein the button and the elastomeric member are provided with suitable formations for connecting them to each other so as to retain the button engaged with the housing.

84. A switch according to claim 83, wherein the connecting formations have interlocking formations or parts, or may fractionally engage each other, or maybe bonded to each other with a suitable adhesive.

85. A switch according to claim 83, wherein the button has a connecting formation for holding it in engagement with the housing, the button and member being arranged and constructed to inhibit lateral movement relatively to each other.

86. A switch according to claim 81, wherein the elastomeric member has at least one projecting formation for pushing one electrical contact against another electrical contact.

87. A switch according to claim 81, wherein the elastomeric member has a conductive formation or coating for electrically bridging two electrical contacts.

88. A switch according to claim 81, including retaining means formed internally of the housing, such as an internal lip or lip portions, for retaining the elastomeric member in the housing.

89. A switch according to claim 81, wherein the elastomeric member has a hollow domed or conical structure.

90. A switch according to claim 81, wherein the housing is substantially rectangular.

91. A switch according to claim 81, wherein the housing is configured externally to be adhesively bonded or welded to one or more other housings.

92. A switch according to claim 81, wherein the housing has interlocking formations for connecting it to another housing.

93. A switch comprising a housing, a button, an elastomeric member substantially contained in the housing for resiliently biassing the button with respect to the housing, and a plurality of interlocking formations for connecting the housing of one switch to the housing of an adjacent switch.

94. A switch according to claim 93, arranged such that there is a base at one side of the housing, the button being positioned on the side of the housing remote from the base.

95. A switch according to claim 93, wherein the interlocking formations comprise bulbed ribs and substantially complementary undercut grooves, the formations of one switch being engageable with the complementary formations of an adjacent switch by sliding the ribs along the grooves.

96. A switch according to claim 95, wherein each of the ribs and grooves has a first portion with a first cross-section, a second portion with a relatively larger cross-section, the material of the housing being sufficiently resilient to permit the second relatively larger portion to pass through the first portion.

97. A switch according to claim 96, wherein the transition between the first and second portions is progressive, or formed by a shoulder or step.

98. A switch according to claim 96, wherein the relative lengths of the first and second portions of each of the rib and the groove formations are chosen such that there is some free play or relative movement of adjacent housings before the shoulders abut one another.

99. A switch according to claim 95, wherein the arrangement of the first and second portions of pairs of ribs and grooves that will be mated in use is such that, once engaged, the housings are inhibited from being separated in either direction along the length of the ribs and grooves.

100. A switch according to claim 95, wherein at least some of the ribs are formed with a double taper along their length, the thickness or cross-section of each rib decreasing outwardly from a medical region of the rib.

101. A switch according to claim 95, wherein at least some of the grooves are formed longitudinally with a double taper, the width or cross-section of the groove decreasing from its ends towards a medical region.

102. A switch according to claim 95, wherein the free ends of at least one of the ribs and grooves is chamfered to facilitate initial engagement of the ribs and grooves.

103. A switch according to claim 95, wherein the elastomeric member is in the form of a dome, the dome having a substantially planar base, a domed portion above the base and a locating formation at the tope region of the dome.

104. A keypad comprising a plurality of switches, each switch comprising a housing, a button, a substantially planar switch member provided with a plurality of pairs of spaced contacts with a pair of contacts being in register with each of the switches, and means for resiliently biasing the button away from the switch member, and means for connecting the switches to each other.

105. A keypad according to claim 104, wherein the planar member is a contact membrane.

106. A keypad according to claim 104, wherein the means for connecting the switches to each other comprises itner-engaging formations formed on the housing of the switches.

107. A keypad according to claim 104, wherein each of the switches is substantially similar to shape and size to enable a regular two-dimensional array to be formed.

108. A keypad according to claim 107, wherein one or more blank housings are provided for filling the interstice(s) between switch housings.

109. A keypad according to claim 108, wherein the blank housings have a height greater than that of the switch housings.

110. A keypad according to claim 108, wherein one or more cover plates or elements engageable with the blank housings are provided.
